(19) United States
(12) Patent Application Publication
(10) Pub. No.: US 2016/0210661 A1
(43) Pub. Date: Jul. 21, 2016

(54) MANAGING DIGITAL MEDIA SPEND ALLOCATION USING CALIBRATED USER-LEVEL ATTRIBUTION DATA

(71) Applicants: Anto Chittilappilly, Waltham, WA (US); Payman Sadegh, Alpharetta, GA (US); Rakesh Pillai, Kerala (IN); Darius Jose, Thrissur (IN)

(72) Inventors: Anto Chittilappilly, Waltham, WA (US); Payman Sadegh, Alpharetta, GA (US); Rakesh Pillai, Kerala (IN); Darius Jose, Thrissur (IN)

(21) Appl. No.: 14/978,489

(22) Filed: Dec. 22, 2015

Related U.S. Application Data
(60) Provisional application No. 62/099,037, filed on Dec. 31, 2014.

(51) Int. Cl. G06Q 30/02

(52) U.S. Cl. CPC G06Q 30/0249; G06Q 30/0246

(57) ABSTRACT

Methods for digital media campaign management. Embodiments determine a set of channel spend allocation values for a plurality of media channels based on a predictive model derived from observed channel response measurements. A stream of one or more touchpoint attribute records that characterize user responses to the media channels are captured and used to calibrate further incoming touchpoint attribute records. The calibrated incoming touchpoint attribute records are used to generate a calibrated touchpoint response predictive model. Outputs of the calibrated touchpoint response predictive model are used to adjust spending in digital media campaigns so as to increase effectiveness. Some embodiments perform calibration by analyzing a series of observed touchpoint events and then reducing the credit applied to the touchpoint events that are farthest from respective conversion events so as to reconcile the touchpoint observations with observed spending in media campaign.

### RELATED APPLICATIONS

The present application claims the benefit of priority to co-pending U.S. Patent Application Ser. No. 62/099,037, entitled “QUANTITATIVE INTEGRATION OF TOP DOWN AND BOTTOM UP ATTRIBUTION” (Attorney Docket No. VISQ.P0006P), filed Dec. 31, 2014 which is hereby incorporated by reference in its entirety.

The present application is related to co-pending U.S. patent application Ser. No. ______ titled, “MANAGING DIGITAL MEDIA SPEND ALLOCATION USING CALIBRATED USER-LEVEL RESPONSE DATA” (Attorney Docket No. VISQ.P0032) filed on even date herewith, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosure relates to the field of digital media campaign management and more particularly to techniques for managing digital media spend allocations.

### BACKGROUND

Current marketing and advertising campaigns involve many media channels to reach a target audience. Such media channels can be digital media channels (e.g., online display, online search, online social, email, etc.) and/or non-digital media channels or offline channels (e.g., TV, radio, print, etc.). The combination of channels are selected by a marketing manager to achieve one or more objectives (e.g., prospect conversion, lead generation, brand recognition, etc.). Allocation of spend on stimulation activity (e.g., placement of marketing messages) in a given channel (e.g., placement of TV ads, placement of online display ads, placement of radio spots, etc.) can sometimes be increased in expectation of increasing the audience response. In some cases, spending in one channel can produce responses in other channels (e.g., more TV ads may increase the likelihood of an online search using certain keywords). A marketing manager desires to know the influence certain channels in a portfolio of media channels have on a given response (e.g., channel attribution) in efforts to improve return on investment and to otherwise optimize spend in such channels.

Certain “top-down” attribution modeling techniques can use channel-level summary stimulus and response data to provide a holistic cross-channel view of all marketing initiatives. Such top-down attribution models can be derived from historical summary data (e.g., using week-by-week data) over a time horizon (e.g., months, years, etc.) such that the effects of seasonality, external factors (e.g., factors other than planned stimuli), digital media channels, non-digital or offline media channels, and/or other marketplace dynamics (e.g., controlled, uncontrolled, etc.) can be modeled. For example, a top-down attribution model might analyze temporal movements in the channel stimulus and response data to develop a predictive model that can estimate the influence respective channels have on a given response (e.g., conversion). The marketing manager can use such predictions to develop an optimized channel media spend plan.

Further, the prevalence of Internet or online advertising and marketing continues to grow at a fast pace. Today, an online user (e.g., prospect) in a given target audience can experience a high number of exposures to a brand and product (e.g., touchpoints) across multiple digital media channels (e.g., display, paid search, paid social, etc.) on the journey to conversion (e.g., buying a product, etc.) and/or to some other engagement state (e.g., brand introduction, brand awareness, etc.). Further, another online user in the same target audience might experience a different combination or permutation of touchpoints and channels, yet might not convert. Large volumes of data characterizing the user interactivity with such a high number of touchpoints is continuously collected in various forms (e.g., touchpoint attribute records, cookies, log files, pixel tags, mobile tracking, etc.) by the online advertising ecosystem using today's always on, always connected Internet technology. The marketing manager of today desires to use this continuous stream of touchpoint data to learn exactly which tactics or touchpoints contribute the most to conversions (e.g., touchpoint attribution) in order to optimize in real time the allocation of marketing budgets to those tactics or touchpoints.

Certain “bottom-up” attribution modeling techniques can collect user-level stimulus and response data (e.g., touchpoint attribute data) to enable tactical optimization of digital media. Such bottom-up attribution models can use a snapshot of touchpoint stimulus and response data to assign conversion credit to every touchpoint and touchpoint attribute (e.g., ad size, placement, publisher, creative, offer, etc.) experienced by every converter and non-converter across all channels. For example, a bottom-up attribution model might apply user engagement stacks to a predictive model to estimate the touchpoint lifts contributing to conversions. The contribution value of a given touchpoint can then be predicted for a given segment of users and/or media channel. The marketing manager can use such predicted contribution values to develop an optimized intra-channel media spend plan.

In some cases, the marketing manager might want to apply a channel media spend allocation using a top-down attribution model, and apply an intra-channel media spend allocation using a bottom-up attribution model. For example, the marketing manager might want to account for seasonality and offline influences in the channel-level media spend allocations using bottom-up attribution models. In some cases, however, a discrepancy can exist between the digital channel attribution predicted by the top-down attribution model and the digital channel attribution predicted by the bottom-up attribution model. For example, while the top-down attribution model might consider the conversion impact of a channel for channel attributions, the bottom-up attribution model might allocate credit to certain touchpoints that are merely part of the conversion path (e.g., not the final converting touchpoint). Such non-converting touchpoints might be assigned little or no credit in a top-down attribution model, yet might be assigned at least some fractional credit in a bottom-up attribution model.

Legacy approaches to reconciling media channel attribution and continually updated digital intra-channel media attribution have limitations. One legacy approach might assign a preference to the bottom-up attribution results by forcing the top-down attribution model to use the digital channel attribution ratios determined by the bottom-up attribution model. Such an approach can reduce the efficacy of the top-down model to accurately predict seasonality, cross-channel impact, and/or other insights. Another approach might add hypothetical (e.g., pseudo-probabilistic) touchpoints to the corpus of touchpoints used to determine a bottom-up attribution model to estimate influences associated with offline, seasonal, exogenous, and/or other factors. Such an approach can still be limited in reconciling media channel attribution and continually updated digital intra-channel media attribution at least when a complete (e.g., accounting for the aforementioned factors) top-down attribution model is available. In some cases, this approach might further increase the discrepancies between the respective attributions predicted by the top-down attribution model and the bottom-up attribution model.

Techniques are therefore needed to address the problem of reconciling media channel attribution based on summary channel response data with digital intra-channel media attribution based on user-level response data continually received over the Internet.

None of the aforementioned legacy approaches achieve the capabilities of the herein-disclosed techniques for managing digital media spend allocation using calibrated user-level response data. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for managing digital media spend allocation using calibrated user-level attribution data.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts techniques for managing digital media spend allocation using calibrated user-level response data, according to some embodiments.

FIG. 1B depicts an environment in which embodiments of the present disclosure can operate,

FIG. 1C depicts techniques for managing digital media spend allocation using calibrated user-level attribution data, according to some embodiments.

FIG. 2A presents a channel response predictive modeling technique used in systems for managing digital media spend allocation using calibrated user-level response data, according to some embodiments.

FIG. 2B presents a channel data display showing sample stimulus and response measurements associated with a media campaign, according to some embodiments.

FIG. 2C illustrates a channel attribution technique, according to some embodiments.

FIG. 3A presents a touchpoint response predictive modeling technique used in systems for managing digital media spend allocation using calibrated user-level response data, according to some embodiments.

FIG. 3B presents a touchpoint attribute chart showing sample attributes associated with touchpoints of a media campaign, according to some embodiments.

FIG. 3C illustrates a touchpoint attribution technique, according to some embodiments.

FIG. 4A depicts a response calibration technique as implemented in systems for managing digital media spend allocation using calibrated user-level response data, according to some embodiments.

FIG. 4B depicts an attribution calibration technique as implemented in systems for managing digital media spend allocation using calibrated user-level attribution data, according to some embodiments.

FIG. 5 depicts a subsystem for managing digital media spend allocation using calibrated user-level response data, according to some embodiments.

FIG. 6 depicts a flow for managing digital media spend allocation using calibrated user-level response data, according to some embodiments.

FIG. 7 is a chart illustrating user interactions for selecting media spend allocations in systems for managing digital media spend allocation using calibrated user-level response data, according to some embodiments.

FIG. 8A is a block diagram of a system for managing digital media spend allocation using calibrated user-level response data, according to an embodiment.

FIG. 8B is a block diagram of a system for managing digital media spend allocation using calibrated user-level attribution data, according to an embodiment.

FIG. 9A and FIG. 9B depict block diagrams of computer system components suitable for implementing embodiments of the present disclosure.

### DETAILED DESCRIPTION

Further details of a predictive model are described in U.S. application Ser. No. 14/145,625 (Attorney Docket No. VISQ.P0004) entitled, “MEDIA SPEND OPTIMIZATION USING CROSS-CHANNEL PREDICTIVE MODEL”, filed Dec. 31, 2013, the contents of which are incorporated by reference in its entirety in this application and in U.S. application Ser. No. 13/492,493 (Attorney Docket No. VISQ.P0003) entitled, “A METHOD AND SYSTEM FOR DETERMINING TOUCHPOINT ATTRIBUTION”, filed Jun. 8, 2012, the contents of which are incorporated by reference in its entirety in this application.

### Overview

Current marketing and advertising campaigns involve many media channels to reach a target audience through marketing activities (e.g., placement of marketing messages) in a given channel (e.g., placement of TV ads, placement of online display ads, placement of radio spots, etc.). Such media channels can be digital media channels (e.g., online display, online search, online social, email, etc.) and/or non-digital media channels or offline channels (e.g., TV, radio, print, etc.). A marketing manager desires to know the influence certain channels in a portfolio of media channels have on a given response (e.g., channel attribution) in efforts to manage spend in such channels. Certain “top-down” attribution modeling techniques can use channel-level summary stimulus and response data to provide a holistic cross-channel view of all marketing initiatives. The marketing manager can use such models to develop an optimized channel media spend plan.

Further, the prevalence of Internet or online advertising and marketing continues to grow at a fast pace. Today, an online user (e.g., prospect) in a given target audience can experience a high number of exposures to a brand and product (e.g., touchpoints) across multiple digital media channels (e.g., display, paid search, paid social, etc.) on the journey to conversion (e.g., buying a product, etc.) and/or to some other engagement state (e.g., brand introduction, brand awareness, etc.). The marketing manager of today desires to use this continuous stream of touchpoint data provided by the Internet to learn exactly which touchpoints contribute the most to conversions (e.g., touchpoint attribution) in order to optimize in real time the allocation of marketing budgets to those tactics. Certain “bottom-up” attribution modeling techniques can collect user-level stimulus and response data (e.g., touchpoint attribute data) to enable tactical optimization of digital media. The marketing manager can use such models to develop an optimized intra-channel media spend plan.

In some cases, the marketing manager might want to apply a channel media spend allocation using a top-down attribution model, and apply an intra-channel media spend allocation using a bottom-up attribution model. For example, the marketing manager might want to account for seasonality and offline influences in the channel-level media spend allocations while considering the digital intra-channel (e.g., touchpoint) media spend allocations that can be continuously changing from online Internet activity. In some cases, however, a discrepancy can exist between the digital channel attribution predicted by the top-down attribution model, and the digital channel attribution predicted by the bottom-up attribution model.

The herein disclosed techniques address such problems using technological techniques for managing digital media spend allocation using calibrated user-level response data. More specifically, the techniques described herein discuss (1) determining channel spend allocation values for a plurality of media channels based on a channel response predictive model; (2) receiving a stream of touchpoint attribute records characterizing user responses to the media channels; (3) calibrating a portion of the touchpoint attribute records using selected channel spend allocation values to provide calibrated touchpoint attribute records; (4) generating a touchpoint response predictive model derived from the calibrated touchpoint attribute records; and (5) providing access to the calibrated touchpoint response predictive model for use by a media spend planning application to enable a marketing manager to specify media spend allocations.

The techniques described herein further discuss (6) generating predicted channel response parameters using the touchpoint response predictive model to be used in deriving the channel response predictive model; and (7) automatically determining the channel spend allocation values based on the predicted channel contribution values generated by the channel response predictive model.

The herein disclosed techniques further address the foregoing problems using technological techniques for managing digital media spend allocation using calibrated user-level attribution data. More specifically, the techniques described herein discuss (1) receiving channel-level attribution parameters characterizing channel-level attributions for various media channels; (2) receiving user-level attribution parameters characterizing user-level attributions for touchpoints in the media channels; (3) mapping certain mapped touchpoints from the touchpoints to the media channels; (4) determining attribution adjustments to apply to the mapped touchpoints to produce a set of calibrated attribution parameters, and (5) delivering the calibrated attribution parameters to a media spend planning application to enable a marketing manager to specify a media spend plan.

The techniques described herein further discuss (6) generating adjusted payment parameters based the attribution adjustments or the calibrated attribution parameters; and (7) aggregating the user-level attributions for the mapped touchpoints to facilitate determining the attribution adjustments.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

### Solutions Rooted in Technology

The appended figures corresponding to the discussion given herein provides sufficient disclosure to make and use systems, methods, and computer program products that address the aforementioned issues with legacy approaches. More specifically, the present disclosure provides a detailed description of techniques used in systems, methods, and in computer program products for managing digital media spend allocation using calibrated user-level response data. Certain embodiments are directed to technological solutions for using media channel attribution and/or allocation values to calibrate current user-level response data for use in generating an intra-channel (e.g., touchpoint) predictive model that can be used to allocate media spend and/or provide feedback to adjust the media channel attribution, which embodiments advance the relevant technical fields, as well as advancing peripheral technical fields. The disclosed embodiments modify and improve over legacy approaches. In particular, the herein-disclosed techniques provide technical solutions that address the technical problems attendant to reconciling media channel attribution based on summary channel historical response data with digital intra-channel media attribution based on user-level response data continually received over the Internet. Such technical solutions serve to reduce use of computer memory, reduce demand for computer processing power, and reduce communication overhead needed.

Specifically, the herein-disclosed techniques address the Internet-centric problem of continually receiving and processing global online user activity data records and combining such data records with batched data records received at various times from other computing devices to provide real-time, reconciled updates to multiple computer-generated predictive models. Some embodiments disclosed herein use techniques to improve the functioning of multiple systems within the disclosed environments, and some embodiments advance peripheral technical fields as well. As one specific example, use of the disclosed techniques and devices within the shown environments as depicted in the FIGS. provide advances in the technical field of high-performance computing as well as advances in various technical fields related to distributed storage.

Reference is now made in detail to certain embodiments. The disclosed embodiments are not intended to be limiting of the claims.

### Descriptions of Exemplary Embodiments

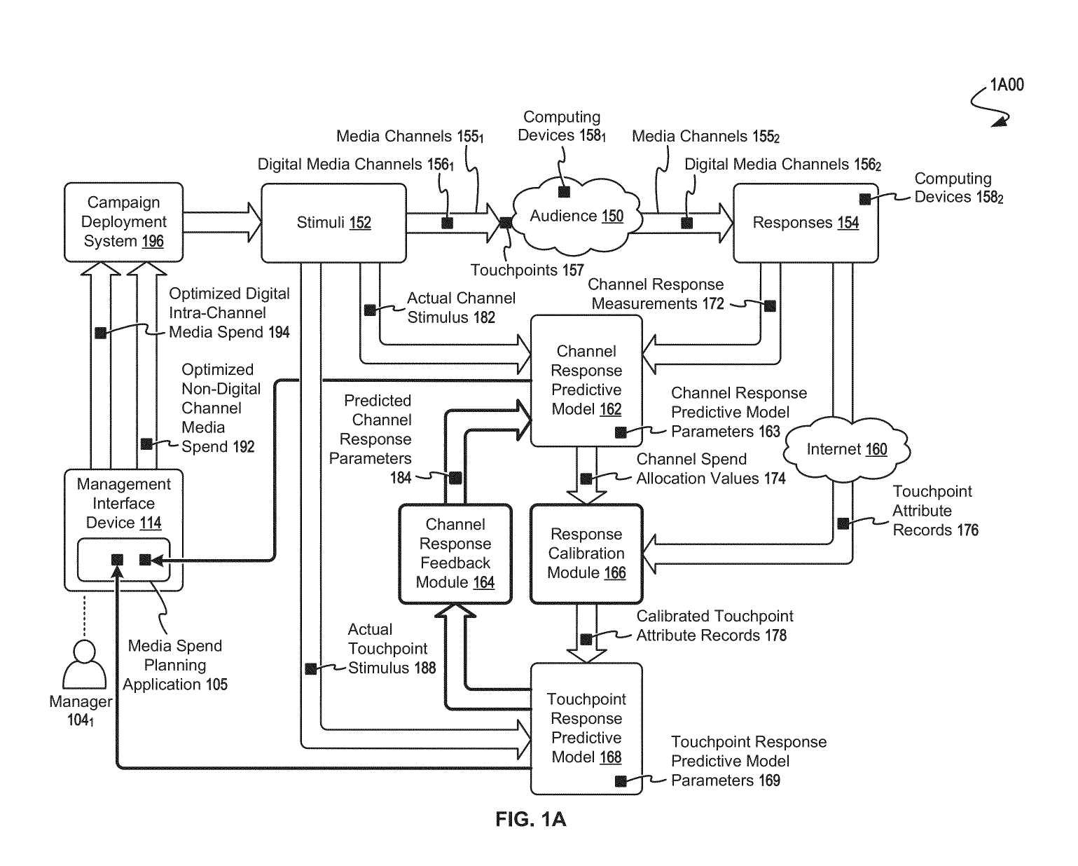

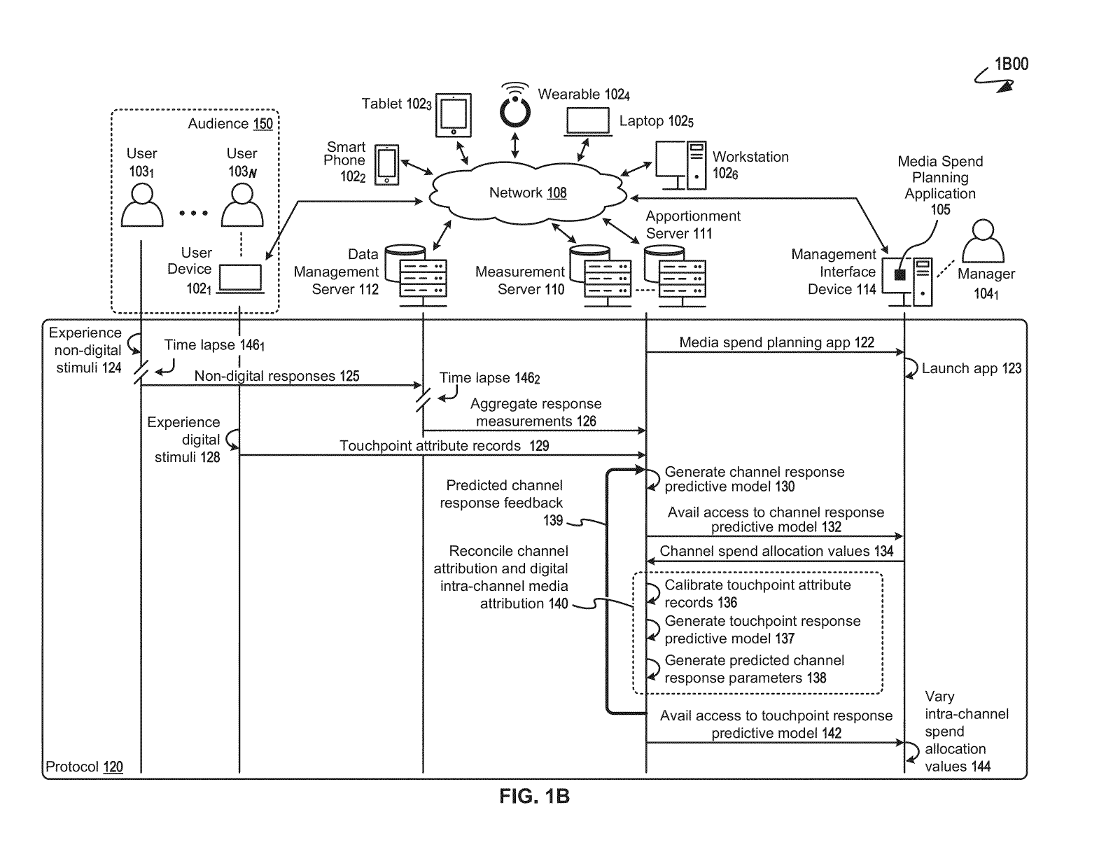

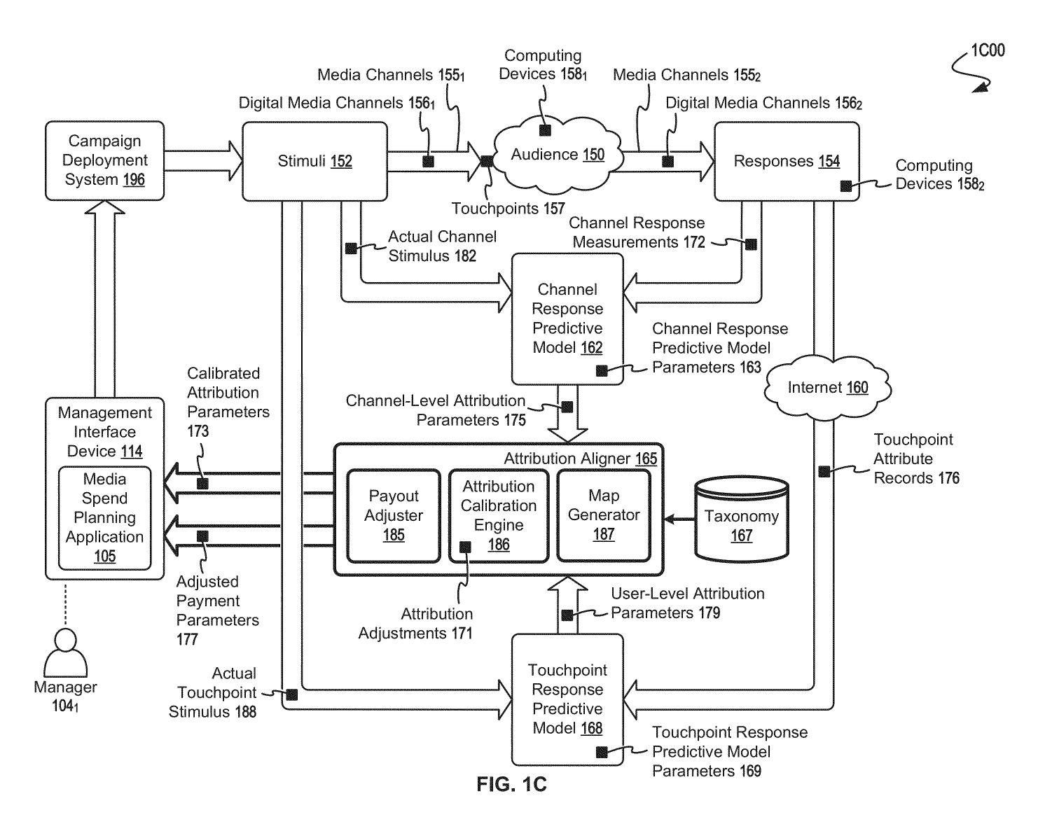

FIG. 1A depicts techniques 1A00 for managing digital media spend allocation using calibrated user-level response data. As an option, one or more instances of techniques 1A00 or any aspect thereof may be implemented in the context of the architecture and functionality of the embodiments described herein. Also, the techniques 1A00 or any aspect thereof may be implemented in any desired environment.

As shown in FIG. 1A, a set of stimuli 152 is presented to an audience 150 (e.g., as part of a marketing campaign) that further produces a set of responses 154. For example, the stimuli 152 might be part of a marketing campaign developed by a marketing manager (e.g., manager 104₁) to reach the audience 150 with the objective to generate user conversions (e.g., sales of a certain product). The stimuli 152 is delivered to the audience 150 through certain instances of media channels 155₁ that can comprise digital media channels 156₁ (e.g., online display, online search, paid social media, email, etc.). The media channels 155₁ can further comprise non-digital media channels (e.g., TV, radio, print, etc.). The audience 150 is exposed to each stimulation comprising the stimuli 152 through a set of touchpoints 157 characterized by certain respective attributes. The responses 154 can also be delivered through other instances of media channels 155₂ that can comprise digital media channels 156₂. In some cases, the information indicating a particular response can be included in the attribute data associated with the instance of touchpoints 157 to which the user is responding. The portion of stimuli 152 delivered through digital media channels 156₁ can be received by the users comprising audience 150 at various instances of computing devices 158₁ (e.g., mobile phone, laptop computer, desktop computer, tablet, etc.). Further, the portion of responses 154 received through digital media channels 156₂ can also be invoked by the users comprising the audience 150 using computing devices 158₁. As shown, some instances of responses 154 might be received, processed, and/or stored by various instances of computing devices 158₂ (e.g., data management platform server, cloud storage services server, etc.).

As further shown, a set of actual channel stimulus 182 and a set of channel response measurements 172 can be used to generate a channel response predictive model 162. The channel response predictive model 162 can be used to provide a holistic cross-channel view of the performance of all the marketing initiatives comprising a certain marketing campaign. Specifically, the channel response predictive model 162 can be characterized in part by a set of channel response predictive model parameters 163 (e.g., equations, equation coefficients, mapping relationships, limits, constraints, etc.) determined to accurately model the relationship between the actual channel stimulus 182 and the channel response measurements 172. The channel response predictive model 162 can be can be formed using any machine learning techniques. For example, the channel response predictive model 162 can use weekly summaries of the actual channel stimulus 182 and the channel response measurements 172 over, for example, the last six months to predict the temporal contributions of each instance (e.g., channel) of the media channels 155₁ to the channel-level conversions comprising the channel response measurements 172. Further, such channel contributions can be used to determine a set of channel spend allocation values 174. For example, the channel response predictive model 162 can be made available to a media spend planning application 105 operating on a management interface device 114 such that the manager 104₁ can manage the media spend. Specifically, the channel response predictive model 162 might indicate that 60% and 40% of responses were attributed to the TV media channel and the online display media channel, respectively. In this case, a $1,000,000 US media spend budget might be apportioned according to a set of recommended allocations comprising $600,000 US to TV and $400,000 US to online display. The manager 104₁ can accept the recommended allocations, or modify any or all of the recommended allocations to specify the set of channel spend allocation values 174.

According to the herein-disclosed techniques, the channel spend allocation values 174 can be used by a response calibration module 166 to calibrate certain instances of touchpoint attribute records 176 received from the Internet 160. As earlier mentioned, such instances of the touchpoint attribute records 176 comprise digital information describing the interactivity of online users in the audience 150 with various instances of the touchpoints 157 experienced in digital stimulus and response channels. Specifically, the response calibration module 166 can process the touchpoint attribute records 176 to produce a set of calibrated touchpoint attribute records 178 that, when aggregated at a channel level, reflect the channel spend allocation values 174. The calibrated touchpoint attribute records 178 and the actual touchpoint stimulus 188 delivered to the audience 150 can then be used to generate a touchpoint response predictive model 168. In some cases, the attributes describing the stimulating touchpoint and the corresponding response information can be delivered in one or more instances of the touchpoint attribute records 176. In some cases, certain touchpoints might have been purchased and served, yet with no user response, such that a record of the stimulating event might only be included in the actual touchpoint stimulus 188. The touchpoint response predictive model 168 can be characterized in part by a set of touchpoint response predictive model parameters 169 (e.g., equations, equation coefficients, mapping relationships, limits, constraints, etc.) determined to accurately model the relationship between the actual touchpoint stimulus 188 and the calibrated touchpoint attribute records 178.

The touchpoint response predictive model 168 can be can be formed using any machine learning techniques. For example, the touchpoint response predictive model 168 can assign conversion credit to every touchpoint and/or touchpoint attribute (e.g., ad size, placement, publisher, creative, offer, etc.) experienced by every converter and non-converter comprising the audience 150 across all digital media response channels. With such a granular attribution capability, the touchpoint response predictive model 168 can be used to enable tactical optimization of digital media campaigns at a user level and/or intra-channel level (e.g., specific touchpoints within the online display channel).

When the touchpoint response predictive model 168 has been formed using the calibrated touchpoint attribute records 178 according to the herein-disclosed techniques, the media channel attribution (e.g., using the channel response predictive model 162) based on summary channel response data (e.g., channel response measurements 172), and the digital intra-channel media attribution (e.g., using the touchpoint response predictive model 168) based on user-level response data continually received over the Internet (e.g., touchpoint attribute records 176) can be reconciled. Further integration of the “top-down” channel-level attribution and the “bottom-up” user-level attribution can be enabled by a channel response feedback module 164. In one or more embodiments, the channel response feedback module 164 uses the touchpoint response predictive model 168 to generate a set of predicted channel response parameters 184 that can be used to further train the channel response predictive model 162. Specifically, the predicted channel response parameters 184 can comprise the aggregated digital channel contribution values derived from the most recent touchpoint data received in real time from the Internet, providing a dynamic feedback loop to continually improve the accuracy of the channel response predictive model 162 and, in turn, the touchpoint response predictive model 168. Using such accurate predictive models, the manager 104₁ can specify both an optimized non-digital channel media spend 192 and an optimized digital intra-channel media spend 194.

The herein-disclosed technological solution described by the techniques 1A00 in FIG. 1A can be implemented in various network computing environments and the associated online and offline marketplaces. Such an environment is discussed as pertains to FIG. 1B.

FIG. 1B depicts an environment 1B00 in which embodiments of the present disclosure can operate. As an option, one or more instances of environment 1B00 or any aspect thereof may be implemented in the context of the architecture and functionality of the embodiments described herein. Also, the environment 1B00 or any aspect thereof may be implemented in any desired environment.

As shown in FIG. 1B, the environment 1B00 comprises various computing systems (e.g., servers and devices) interconnected by a network 108. The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 1B00 comprises at least one instance of a measurement server 110, at least one instance of an apportionment server 111, at least one instance of a data management server 112, and at least one instance of a management interface device 114. The servers and devices shown in environment 1B00 can represent any single computing system with dedicated hardware and software, multiple computing systems clustered together (e.g., a server farm, a host farm, etc.), a portion of shared resources on one or more computing systems (e.g., a virtual server), or any combination thereof. For example, the measurement server 110 and the apportionment server 111 might be closely coupled (e.g., co-located, same hardware server, etc.) as illustrated.

The environment 1B00 further comprises at least one instance of a user device 102₁ that can represent one of a variety of other computing devices (e.g., a smart phone 102₂, a tablet 102₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 102₁ can further communicate information (e.g., web page request, user activity, electronic files, computer files, etc.) over the network 108. The user device 102₁ can be operated by a user 103_{N}. Other users (e.g., user 103₁) with or without a corresponding user device can comprise the audience 150. Also, and as shown in FIG. 1A, the media spend planning application 105 can be operating on the management interface device 114 and accessible by the manager 104₁.

As shown, the user 103₁, the user device 102₁ (e.g., by user 103_{N}), the data management server 112, the measurement server 110 and apportionment server 111, and the management interface device 114 can perform a set of high-level interactions (e.g., operations, messages, etc.) in a protocol 120. Specifically, the protocol can represent interactions in systems for managing digital media spend allocation using calibrated user-level response data. As shown, the manager 104₁ can download the media spend planning application 105 from the measurement server 110 to the management interface device 114 (see message 122) and launch the application (see operation 123). Users in the audience 150 can also experience and interact with various marketing campaign stimuli delivered through certain media channels. For example, user 103₁ might experience certain non-digital (e.g., offline) stimuli (see operation 124), such as a TV advertisement and/or a coupon in the mail. The user 103₁ might later take one or more measurable actions (e.g., TV call center purchase, coupon scan at store) that can be captured as non-digital responses by the data management server 112 (see message 125). Such non-digital channel response measurements can be aggregated (e.g., summarized by channel) and delivered in batch files (e.g., weekly) to the measurement server 110 by the data management server 112 (see message 126). In some cases, there can be a delay between the user action and the recording of such action at the measurement server 110. For example, a call center might compile weekly reports (e.g., time lapse 146₁) that are delivered to a data aggregator (e.g., data management server 112) and then processed and forwarded to certain data consumers (e.g., measurement server 110) after some delay (e.g., time lapse 146₂). Further, the user 103_{N} might experience certain digital (e.g., online) stimuli (see operation 128) such as a display ad touchpoint and/or a paid search touchpoint. The user 103_{N} might respond to the touchpoints (e.g., clicking the display ad) such that one or more touchpoint attribute records are delivered to the measurement server 110 (see message 129). For example, the attributes associated with the touchpoint (e.g., touchpoint attributes, cookie information, device information, etc.) can be collected and sent over the network 108 (e.g., using HTTP, HTTPS, etc.) immediately responsive to the user action (e.g., clicking the display ad). In some cases, instances of the data management server 112 can further deliver batch files to the measurement server 110 comprising aggregated (e.g., by channel) digital channel response data (see message 126).

Using the received non-digital and digital summary channel responses, the measurement server 110 can generate a channel response predictive model (see operation 130). Such a model can provide a holistic cross-channel view of the contribution of each channel to achieving the objective of the marketing campaign. The most updated version of the channel response predictive model can be made available to the management interface device 114 (see message 132) such that the manager 104₁ can test various channel spend scenarios and select certain media channel spend allocation values (see message 134). The measurement server 110 can use the channel spend allocation values to calibrate a certain portion of the received touchpoint attribute records (see operation 136). For example, since the touchpoint attribute records are continually streaming in from the network 108, the touchpoint attribute records from the previous week might be selected for calibration. Using the calibrated touchpoint attribute records, a touchpoint response predictive model can be generated (see operation 137). In one or more embodiments, the measurement server 110 can further use the touchpoint response predictive model to generate predicted digital channel response parameters (see operation 138) to be delivered as feedback (see message 139) to update the channel response predictive model using the most recent touchpoint response data from the Internet. The touchpoint response predictive model can further be made available to the management interface device 114 (see message 142) such that the manager 104₁ can test various digital intra-channel spend scenarios and select certain intra-channel spend allocation values (see operation 144).

As shown in FIG. 1B, the techniques disclosed herein address the problems attendant to reconciling media channel attribution based on summary channel response data with digital intra-channel media attribution based on user-level response data continually received over the Internet (see operations 140). Specifically, the protocol 120 and the environment 1B00 illustrate that the herein-disclosed techniques address the Internet-centric problem of continually receiving and processing global online user activity data records (see message 129) and combining such data records with batched data records received at various times from other computing devices (see message 126) to provide real-time, reconciled updates to multiple computer-generated predictive models (see operations 140) for access by marketing managers running software applications on various online interface devices (see message 132 and message 142). More details pertaining such predictive models are discussed infra.

FIG. 1C presents another embodiment of the herein disclosed techniques for addressing the problems attendant to reconciling media channel attribution based on summary channel response data with digital intra-channel media attribution based on user-level response data continually received over the Internet.

FIG. 1C depicts techniques 1C00 for managing digital media spend allocation using calibrated user-level response data. As an option, one or more instances of techniques 1A00 or any aspect thereof may be implemented in the context of the architecture and functionality of the embodiments described herein. Also, the techniques 1A00 or any aspect thereof may be implemented in any desired environment.

As shown, FIG. 1C comprises several components earlier described in FIG. 1A. Specifically, the stimuli 152 is shown being presented to the audience 150 that further produces the responses 154. Also, the actual channel stimulus 182 (e.g., from the stimuli 152) and the channel response measurements 172 (e.g., from the responses 154) can be used to generate the channel response predictive model 162. Further, in one or more embodiments, the actual touchpoint stimulus 188 and the touchpoint attribute records 176 received over the Internet 160 can be used to generate the touchpoint response predictive model 168. As shown, the channel response predictive model 162 can further be used to generate a set of channel-level attribution parameters 175 characterizing the attribution of conversion credit to various media channels. The touchpoint response predictive model 168 can be used to generate a set of user-level attribution parameters 179 characterizing the attribution of conversion credit to various touchpoints and/or touchpoint attributes (e.g., ad size, placement, publisher, creative, offer, etc.) experienced by every converter and non-converter comprising the audience 150 across all digital media response channels. In some cases, the channel-level attribution described by the channel-level attribution parameters 175 and an aggregated channel view of the touchpoint attribution described by the user-level attribution parameters 179 can exhibit inconsistencies.

Such inconsistencies can be addressed by the techniques 1C00 depicted in FIG. 1C. Specifically, an attribution aligner 165 can receive the channel-level attribution parameters 175 and the user-level attribution parameters 179 to generate a set of calibrated attribution parameters 173 and/or a set of adjusted payment parameters 177. More specifically, a map generator 187 in the attribution aligner 165 can map the various channels from the channel-level attribution parameters 175 to certain touchpoints associated with the user-level attribution parameters 179. For example, the channel-level attribution parameters 175 might describe an attribution for a “Display” channel that can be mapped to various touchpoints associated with the “Display” channel. In some cases, a taxonomy 167 can be used to facilitate the mapping. For example, the taxonomy 167 might comprise a table of attribute key and attribute value pairs associated with a given channel as follows:

TABLE 1
Example Taxonomy

| Channel | Attribute | Attribute Value |
|---|---|---|
| Display | Channel | Display |
| Display | Touchpoint Type | Impression |
| Display | Placement | All |
| Display | Creative | All |
| Display | Retarget Indicator | False |

The mapping of touchpoints to channels generated by the map generator 187 can be used by an attribution calibration engine 186 to reconcile certain inconsistencies exhibited by the channel-level attribution parameters 175 and the user-level attribution parameters 179. For example, a “Display” attribution value from the channel-level attribution parameters 175 and a user-level aggregate attribution derived from a portion of the user-level attribution parameters 179 associated with the touchpoints mapped to the “Display” channel can be used to determine an instance of the attribution adjustments 171. Various techniques for determining the attribution adjustments 171 are possible. The attribution adjustment can be used to calibrate the attribution of each touchpoint mapped to the “Display” channel such that the user-level attribution (e.g., bottom-up attribution) is consistent (e.g., reconciled) with the channel-level attribution (e.g., top-down attribution). Such adjustments can be applied to other channels of interest (e.g., channels comprising a given marketing campaign). The adjusted touchpoint attributions and/or the channel attributions can be described by various parameters comprising the calibrated attribution parameters 173. A payout adjuster 185 can determine the adjusted payment parameters 177 based in part on the calibrated attribution parameters 173. For example, the adjusted payment parameters 177 might represent a set of payments (e.g., to various entities in the campaign deployment system 196) that reflect the reconciled channel-level and user-level attributions.

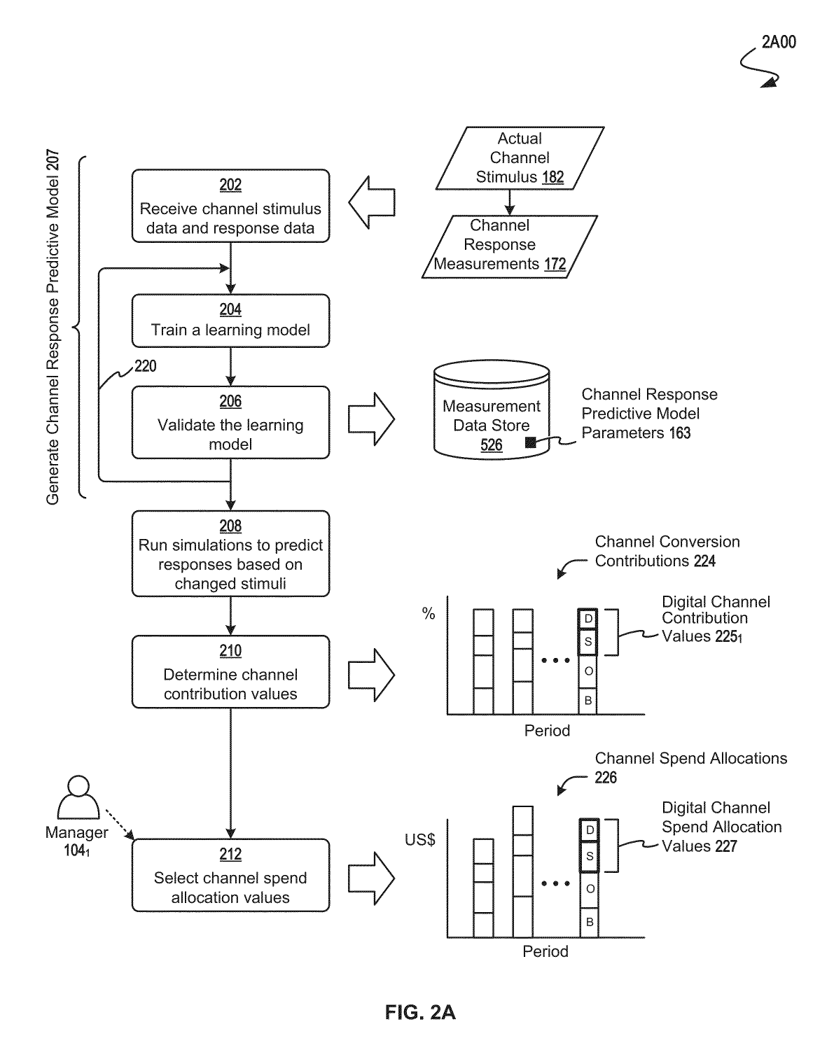

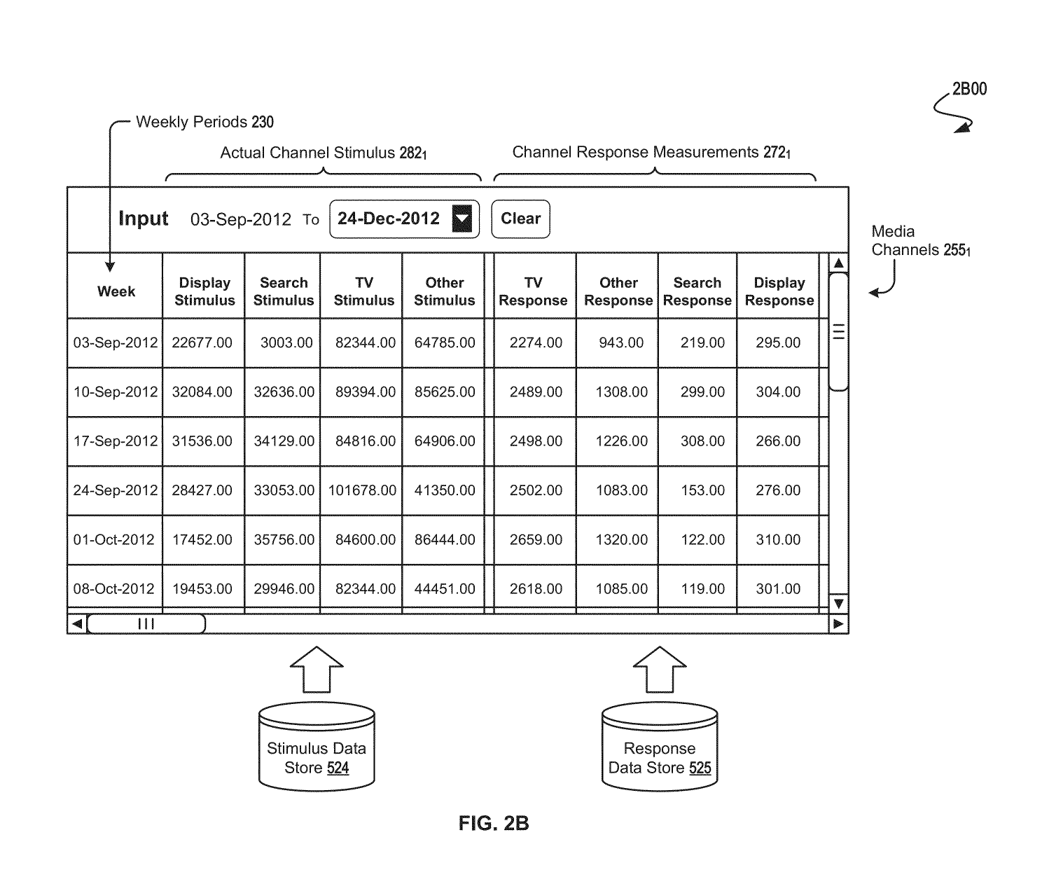

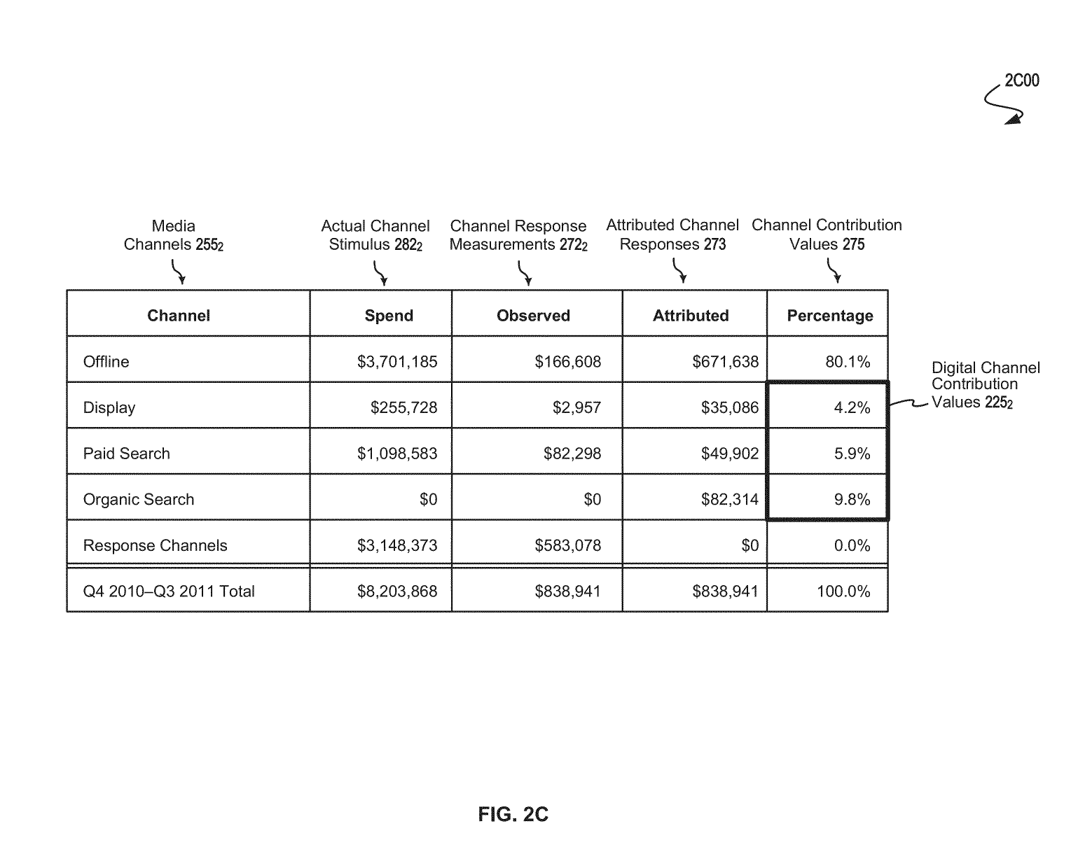

FIG. 2A presents a channel response predictive modeling technique 2A00 used in systems for managing digital media spend allocation using calibrated user-level response data. As an option, one or more instances of channel response predictive modeling technique 2A00 or any aspect thereof may be implemented in the context of the architecture and functionality of the embodiments described herein. Also, the channel response predictive modeling technique 2A00 or any aspect thereof may be implemented in any desired environment.

FIG. 2A depicts process steps (e.g., channel response predictive modeling technique 2A00) used in the generation of a channel response predictive model (see grouping 207). As shown, actual channel stimulus 182 and channel response measurements 172 associated with one or more historical marketing campaigns and/or time periods are received by a computing device and/or system (e.g., measurement server 110) over a network (see step 202). The information associated with the actual channel stimulus 182 and channel response measurements 172 can be organized into various data structures (e.g., see FIG. 2B). A portion of the collected stimulus and response data can be used to train a learning model (see step 204). A different portion of the collected stimulus and response data can be used to validate the learning model (see step 206). The processes of training and validating can be iterated (see path 220) until the learning model behaves within target tolerances (e.g., with respect to predictive statistic metrics, descriptive statistics, significance tests, etc.). In some cases, additional historical stimulus and response data can be collected to further train the learning model. When the learning model has been generated, the parameters (e.g., channel response predictive model parameters 163) describing the learning model (e.g., channel response predictive model 162) can be stored in a measurement data store 526 for access by various computing devices (e.g., measurement server 110, management interface device 114, apportionment server 111, etc.).

Specifically, the learning model (e.g., channel response predictive model 162) might be used to run simulations (e.g., at the apportionment server 111) to predict responses based on changed stimuli (see step 208) such that contribution values for each channel can be determined (see step 210). For example, a sensitivity analysis can be performed using the channel response predictive model 162 to generate a chart showing the channel conversion contributions 224 over the studied periods. Specifically, a percentage contribution for a display (“D”) channel, a search (“S”) channel, an offline (“O”) channel, and a base (“B”) channel (e.g., related to responses not statistically attributable to any channel, such as those related to brand equity) can be determined for each period (e.g., week). A set of digital channel contribution values 225₁ and non-digital channel contribution values (e.g., for offline, base, etc.) can be determined. Further, a marketing manager (e.g., manager 104₁) can use the channel conversion contributions 224 to further allocate spend among the various media channels by selecting associated channel spend allocation values (see step 212). For example, the manager 104₁ might apply an overall periodic marketing budget (e.g., in $US) to the various channels according to the relative channel contributions presented in the channel conversion contributions 224 to produce certain instances of channel spend allocations 226 for each analyzed period. In some cases, the channel spend allocations 226 can be automatically generated based on the channel conversion contributions 224. As shown, a set of digital channel spend allocation values 227 and non-digital channel spend allocation values (e.g., for offline, base, etc.) can be determined. Embodiments of certain data structures used by the channel response predictive modeling technique 2A00 are described in FIG. 2B and FIG. 2C.

FIG. 2B presents a channel data display 2B00 showing sample stimulus and response measurements associated with a media campaign. As an option, one or more instances of channel data display 2B00 or any aspect thereof may be implemented in the context of the architecture and functionality of the embodiments described herein. Also, the channel data display 2B00 or any aspect thereof may be implemented in any desired environment.

As shown, the channel data display 2B00 presents summary level channel stimuli and response metrics that have been aggregated for a certain time period. In one or more embodiments, the channel data display 2B00 can be presented to a marketing manager in the media spend planning application 105 on the management interface device 114. Specifically, the channel data display 2B00 shows a set of actual channel stimulus 282₁ and a set of channel response measurements 272₁ for certain instances of media channels 255₁ and certain instances of weekly periods 230. In some embodiments, the measurement server 110 can receive and store the electronic data records comprising the set of actual channel stimulus 282₁ and the set of channel response measurements 272₁ in a stimulus data store 524 and a response data store 525, respectively. For example, for a given week (e.g., 17 Sep. 2012), the data collected and presented in the channel data display 2B00 might represent the spending (e.g., in $US) paid for delivering the set of actual channel stimulus 282₁ (e.g., Display Stimulus=$31,536.00 US) and the revenue associated with the set of channel response measurements 272₁ (e.g., TV Response=$2,498.00 US). Other metrics (e.g., number of impressions, number of clicks, etc.) to characterize the stimuli and responses are possible. Such metrics can be used to generate a channel response predictive model that can estimate channel contribution values as described in FIG. 2C.

FIG. 2C illustrates a channel attribution technique 2C00. As an option, one or more instances of channel attribution technique 2C00 or any aspect thereof may be implemented in the context of the architecture and functionality of the embodiments described herein. Also, the channel attribution technique 2C00 or any aspect thereof may be implemented in any desired environment.

The shown channel attribution technique 2C00 depicts various measures of attribution (e.g., credit for a conversion) for a given time period across multiple channels in a marketing campaign. In one or more embodiments, the channel attribution technique 2C00 can be implemented by the measurement server 110 in environment 1B00. Specifically, the channel attribution technique 2C00 depicts a set of media channels 255₂, namely “Offline”, “Display”, “Paid Search”, “Organic Search”, and “Response Channels” (e.g., TV ad asking consumer to respond directly to a company, etc.). A set of actual channel stimulus 282₂ for each channel (e.g., $US spent in a respective channel) is also depicted. A set of channel response measurements 272₂ observed for each channel (e.g., $US sales revenue) is also depicted. Other metrics (e.g., number of impressions, number of clicks, etc.) to characterize the stimuli and responses are possible. Further, in the shown channel attribution technique 2C00, a set of attributed channel responses 273 and a set of channel contribution values 275 (e.g., as percentages of total responses) are also depicted. In one or more embodiments, the attributed channel responses 273 and associated set of channel contribution values 275 can be generated by the channel response predictive model 162. The channel contribution values 275 can further be used by the herein disclosed techniques to calibrate current user-level response data (e.g., touchpoint attribute records 176) for use in generating an intra-channel predictive model (e.g., touchpoint response predictive model 168) that can be used to optimize media spend allocation and/or provide feedback to further improve the accuracy of the channel contribution values 275.

For example, referring to the channel attribution technique 2C00, the largest (e.g., $583,078 US) of the set of channel response measurements 272₂ is associated with the “Response Channels”. Such “Response Channels” might comprise channels that enable a user (e.g., customer, prospect, etc.) to initiate a desired action in response to exposure to a marketing stimulation (e.g., from the set of actual channel stimulus 282₂) created by a stimulation channel (e.g., media channels 255₂). Further, no portion of the channel response measurements are associated with “Organic Search”. Such results might reflect a relative ability (or inability) to measure a response in a given channel. For example, the “Response Channels” (e.g., ecommerce website, mobile website, traditional retail store, call center, etc.) are designed to readily observe responses (e.g., the user completes a purchase), yet difficult to observe in the “Organic Search” channels (e.g., a user clicks a link from search results). A predictive model, such as the channel response predictive model 162, can account for the cross-channel effects and/or other effects that can lead to a measured response, and attribute such measured responses to the stimulus channels most influential in producing the response.

Specifically, the channel attribution technique 2C00 reveals that no responses might be attributed to the “Response Channels”, even with a large percentage of measured responses (e.g., conversions) occurring in that channel. Rather, the channel attribution technique 2C00 indicates that contribution credits applied to the set of channel response measurements 272₂ can be distributed as shown in the attributed channel responses 273. For example, the “Offline” channel (e.g., TV, radio, etc.) increased from a measured response of $166,608 US to an attributed response of $671,638 US (e.g., 80.1% of total channel contribution value). Also, the “Organic Search” channel increased from a measured response of $0 to an attributed response of $82,314 US (e.g., 9.8% of total channel contribution value). Given the information provided by the channel attribution technique 2C00, and other results provided by the techniques disclosed herein, the marketing manager can more effectively direct resources (e.g., channel spending) to achieve a desired outcome (e.g., higher unit or dollar volume of sales, higher awareness, improved sentiment, higher likelihood of action, etc.).

Specifically, the marketing manager can consider the digital channel contribution values 225₂ when allocating media spend to digital channels. As illustrated in FIG. 2C, the contribution of the “Organic Search” channel can be considered by the marketing manager in digital channel spend decisions, yet such “organic” channels do not have a corresponding set of stimuli (e.g., touchpoints) that can be identified for the channel. In comparison, the “Display” and “Paid Search” channels can have associated stimuli to which media spend can be allocated according to the digital channel contribution values 225₂. More specifically, the digital channel contribution values 225₂ can be used with the touchpoint response predictive modeling technique, and associated data structures described in the following figures, to implement the herein disclosed techniques for managing digital media spend allocation using calibrated user-level response data.

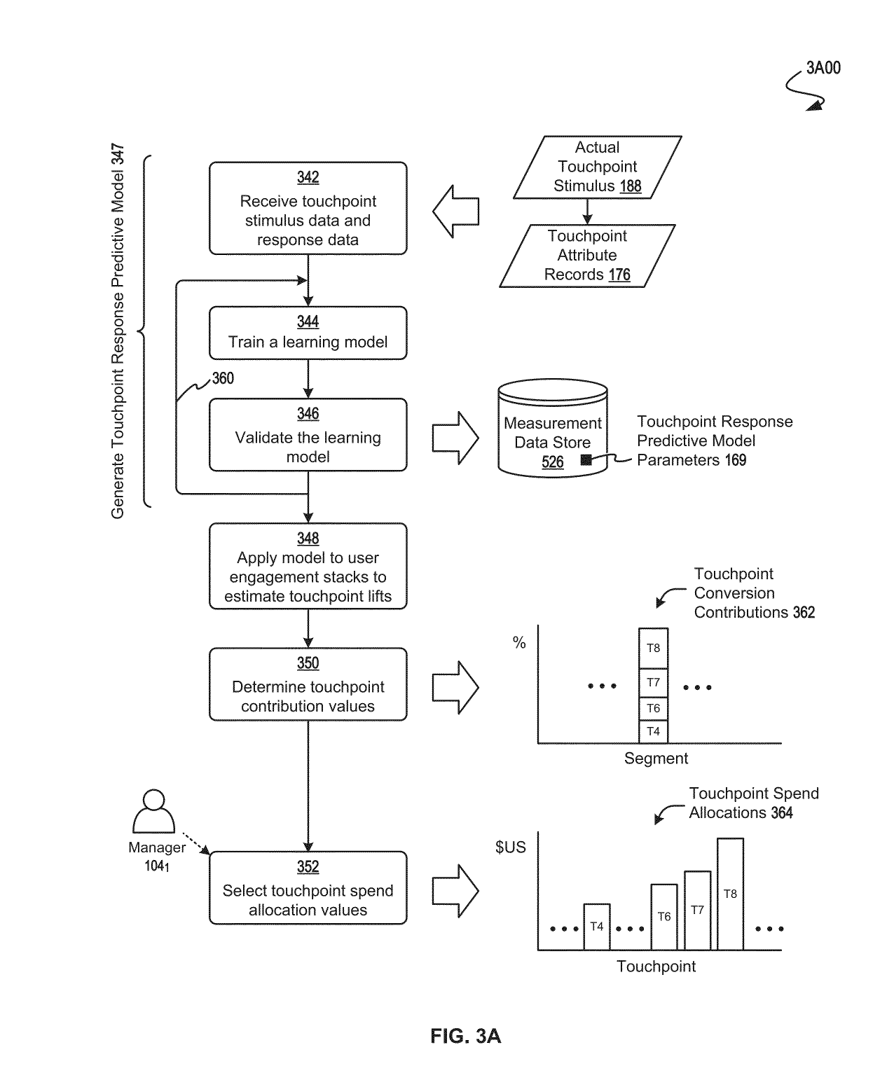

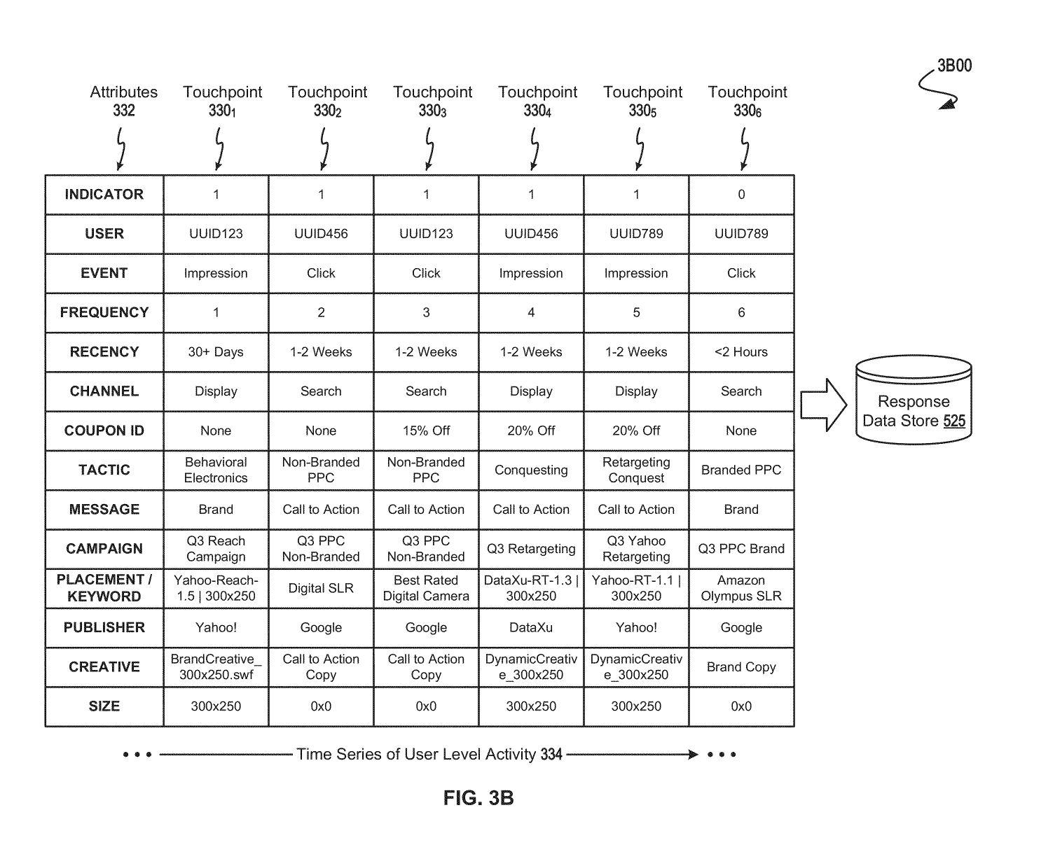

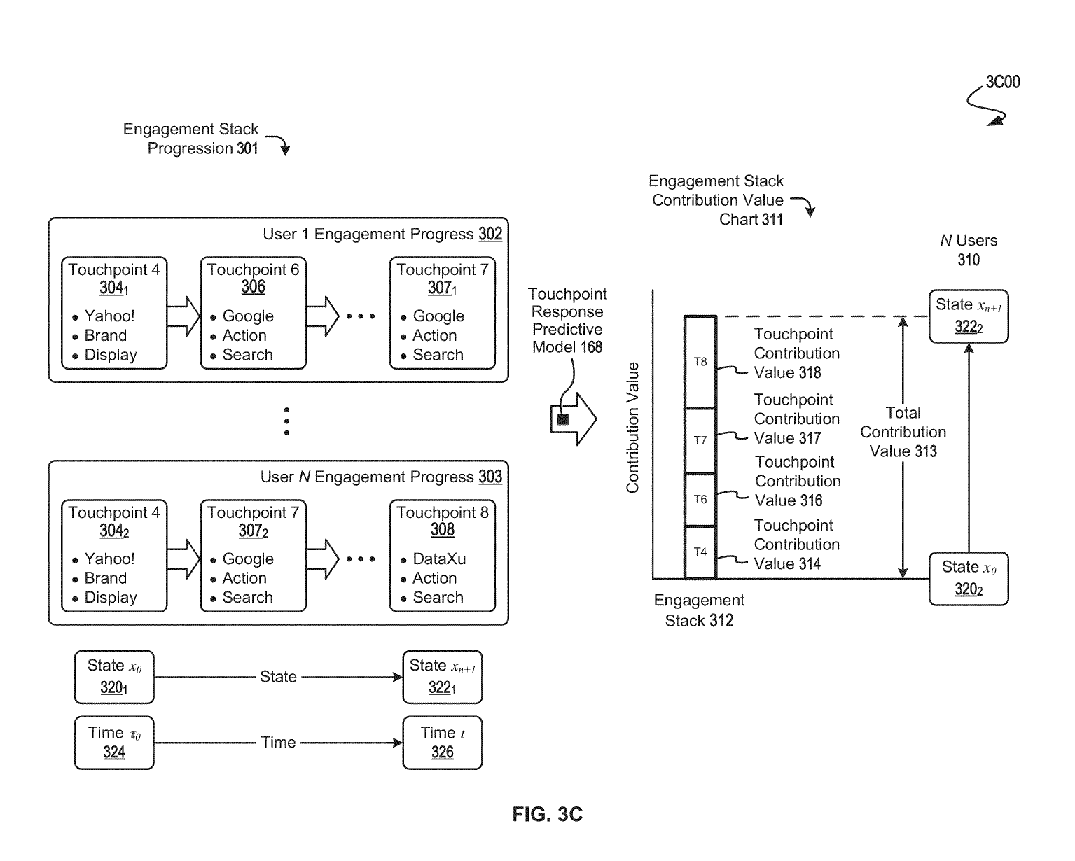

FIG. 3A presents a touchpoint response predictive modeling technique 3A00 used in systems for managing digital media spend allocation using calibrated user-level response data. As an option, one or more instances of touchpoint response predictive modeling technique 3A00 or any aspect thereof may be implemented in the context of the architecture and functionality of the embodiments described herein. Also, the touchpoint response predictive modeling technique 3A00 or any aspect thereof may be implemented in any desired environment.

FIG. 3A depicts process steps (e.g., touchpoint response predictive modeling technique 3A00) used in the generation of a touchpoint response predictive model (see grouping 347). As shown, actual touchpoint stimulus 188 and touchpoint attribute records 176 (e.g., responses) associated with one or more marketing campaigns can be continually received by a computing device and/or system (e.g., measurement server 110) over a network (see step 342). The information associated with the actual touchpoint stimulus 188 and touchpoint attribute records 176 can be organized into various data structures (e.g., see FIG. 3B). A portion of the collected touchpoint stimulus and response data can be used to train a learning model (see step 344). A different portion of the collected stimulus and response data can be used to validate the learning model (see step 346). The processes of training and validating can be iterated (see path 360) until the learning model behaves within target tolerances (e.g., with respect to predictive statistic metrics, descriptive statistics, significance tests, etc.). In some cases, additional stimulus and response data can be collected to further train the learning model. When the learning model has been generated, the parameters (e.g., touchpoint response predictive model parameters 169) describing the learning model (e.g., touchpoint response predictive model 168) can be stored in the measurement data store 526 for access by various computing devices (e.g., measurement server 110, management interface device 114, apportionment server 111, etc.).

Specifically, the learning model (e.g., touchpoint response predictive model 168) might be applied to certain user engagement stacks to estimate the touchpoint lifts contributing to conversions (see step 348). The contribution value of a given touchpoint can then be determined (see step 350) for a given segment of users and/or media channel. For example, executing step 348 and step 350 might generate a chart showing the touchpoint conversion contributions 362 for a given segment. Specifically, a percentage contribution for a Touchpoint4 (“T4”), a Touchpoint6 (“T6”), a Touchpoint7 (“T7”), and a Touchpoints (“T8”) can be determined for the segment (e.g., all users, male users, weekend users, California users, etc.). Further, a marketing manager (e.g., manager 104₁) can use the touchpoint conversion contributions 362 to further allocate spend among the various touchpoints by selecting associated touchpoint spend allocation values (see step 352). For example, the manager 104₁ might apply an overall marketing budget (e.g., in $US) for digital media channels to the various intra-channel touchpoints. In some cases, the manager 104₁ can allocate the budget according to the relative touchpoint contributions presented in the touchpoint conversion contributions 362 to produce certain instances of touchpoint spend allocations 364 as shown. In other cases, the touchpoint spend allocations 364 can be automatically generated based on the touchpoint conversion contributions 362. Embodiments of certain data structures used by the touchpoint response predictive modeling technique 3A00 are described in FIG. 3B and FIG. 3C.

FIG. 3B presents a touchpoint attribute chart 3B00 showing sample attributes associated with touchpoints of a media campaign. As an option, one or more instances of touchpoint attribute chart 3B00 or any aspect thereof may be implemented in the context of the architecture and functionality of the embodiments described herein. Also, the touchpoint attribute chart 3B00 or any aspect thereof may be implemented in any desired environment.

As discussed herein, a touchpoint (e.g., touchpoints 157) can be any occurrence where a user interacts with any aspect of a media campaign (e.g., display ad, keyword search, TV ad, etc.). Recording the various stimulation and response touchpoints associated with a marketing campaign can occur over a time period (e.g., see time series of user level activity 334), which stimulation and response touchpoints or records therefrom can enable certain key performance indicators for the campaign to be determined. Yet, some touchpoints are more readily observed than other touchpoints. Specifically, touchpoints in non-digital media channels might be not be observable at a user level and/or an individual transaction level such that summary and/or aggregate responses in non-digital channels are provided. In comparison, touchpoints in digital media channels can be captured in real-time at a user level (e.g., using Internet technology). The attributes of such touchpoints in digital media channels can be structured as depicted in the touchpoint attribute chart 3B00. Specifically, the touchpoint attribute chart 3B00 shows a plurality of touchpoints (e.g., touchpoint 330₁, touchpoint 330₂, touchpoint 330₃, touchpoint 330₄, touchpoint 330₅, and touchpoint 330₆) that might be collected and stored (e.g., in response data store 525) for various analyses (e.g., at measurement server 110 and apportionment server 111). The example dataset of touchpoint attribute chart 3B00 correlates the various touchpoints with a plurality of attributes 332 associated with respective touchpoints.

For example, the attribute “Channel” identifies the type of channel (e.g., “Display”, “Search”) that delivers the touchpoint, the attribute “Message” identifies the type of message (e.g., “Brand”, “Call to Action”) delivered in the touchpoint, and so on. More specifically, as indicated by the “Event” attribute, touchpoint 330₁ was an “Impression” presented to the user, while touchpoint 330₂ corresponds to an item (e.g., “Call to Action” for “Digital SLR”) that the user responded to with a “Click”. Also, as indicated by the “Indicator” attribute, touchpoint 330₁ was presented in a certain specified time window (e.g., as indicated by a “1”), while touchpoint 330₆ was not presented in the specified time window (e.g., as indicated by a “0”). For example, the “Indicator” can be used to distinguish the actual touchpoint stimulus 188 experienced by a user as compared to planned touchpoint stimulus. Further, as indicated by the “User” attribute, touchpoint 330₁ was presented to a user identified as “UUID123”, while touchpoint 330₂ was presented to a user identified as “UUID456”. The remaining information in the touchpoint attribute chart 3B00 identifies other attribute values for the plurality of touchpoints.

A measurable relationship between one or more touchpoints and a progression through engagement and/or readiness states towards a target state is possible. Such a collection of touchpoints contributing to reaching the target state (e.g., conversion) can be called an engagement stack. Indeed, such engagements stacks can be implemented by the foregoing touchpoint response predictive modeling technique 3A00 for the purpose of attributing a contribution of certain touchpoints to achievement of desired responses, such as conversion (e.g., touchpoint conversion contribution 362). When analyzing the impact of touchpoints on a user's engagement progression and possible conversion, a time-based progression view of the touchpoints and a stacked engagement contribution value of the touchpoints can be considered as shown in FIG. 3C.

FIG. 3C illustrates a touchpoint attribution technique 3C00. As an option, one or more instances of touchpoint attribution technique 3C00 or any aspect thereof may be implemented in the context of the architecture and functionality of the embodiments described herein. Also, the touchpoint attribution technique 3C00 or any aspect thereof may be implemented in any desired environment.

The touchpoint attribution technique 3C00 illustrates an engagement stack progression 301 that is transformed by the touchpoint response predictive model 168 to an engagement stack contribution value chart 311. Specifically, the engagement stack progression 301 depicts a progression of touchpoints experienced by one or more users. More specifically, a User 1 engagement progress 302 and a User N engagement progress 303 are shown as representative of a given audience (e.g., comprising User 1 to User N). The User 1 engagement progress 302 and the User N engagement progress 303 represent the user's progress from a state x₀ 320₁ to a state xₙ₊₁ 322₁ over a time τ₀ 324 to a time t 326. For example, the state x₀ 320₁ can represent an initial user engagement state (e.g., no engagement) and the state xₙ₊₁ 322₁ can represent a final user engagement state (e.g., conversion). Further, the time τ₀ 324 to the time t 326 can represent a measurement time window for performing touchpoint attribution analyses.

As shown in User 1 engagement progress 302, User 1 might experience a Touchpoint T4 304₁ comprising a branding display creative published by Yahoo!. At some later moment, User 1 might experience a Touchpoint T6 306 comprising Google search results (e.g., search keyword “Digital SLR”) prompting a call to action. At yet another moment later in time, User 1 might experience a Touchpoint T7 307₁ comprising Google search results (e.g., search keyword “Best Rated Digital Camera”) also prompting a call to action. Also, and as depicted in the shown User N engagement progress 303, User N might experience a Touchpoint T4 304₂ having the same attributes as Touchpoint T4 304₁. At some later moment, User N might experience a Touchpoint T7 307₂ having the same attributes as Touchpoint T7 307₁. At yet another moment later in time, User N might experience a Touchpoint T8 308 comprising a call-to-action display creative published by Data Xu. Any number of timestamped occurrences of these touchpoints and/or additional information pertaining to the touchpoints and/or user responses to the touchpoints (e.g., captured in attributes 332), can be received over the network in real time for use in generating the touchpoint response predictive model 168 and the resulting engagement stack contribution value chart 311. Any one or more of the aforementioned user responses can be classified as a positive response (e.g., where the same user takes an additional measured action), or a non-positive response (e.g., where the same user does not take additional measured actions).

The engagement stack contribution value chart 311 shows the “stack” of contribution values (e.g., touchpoint contribution value 314, touchpoint contribution value 316, touchpoint contribution value 317, and touchpoint contribution value 318) of the respective touchpoints (e.g., T4, T6, T7, and T8) of engagement stack 312. The overall contribution value of the engagement stack 312 is defined by a total contribution value 313. Various techniques (e.g., the touchpoint response predictive modeling technique 3A00) can determine the contribution value from the available touchpoint data (e.g., touchpoint attribute records 176, calibrated touchpoint attribute records 178, etc.). As shown, the contribution values indicate a relative contribution (e.g., lift) a respective touchpoint has on transitioning the subject audience segment (e.g., N Users 310) from state x₀ 320₂ to state xₙ₊₁ 322₂.

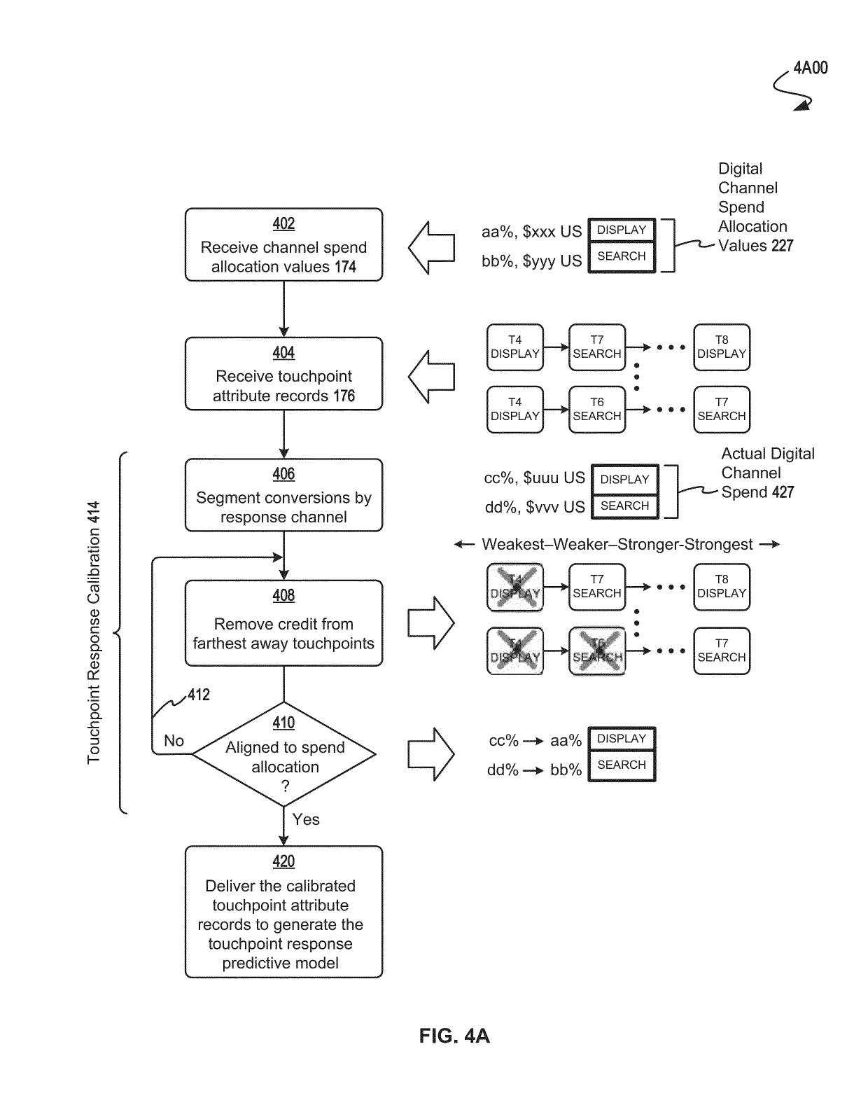

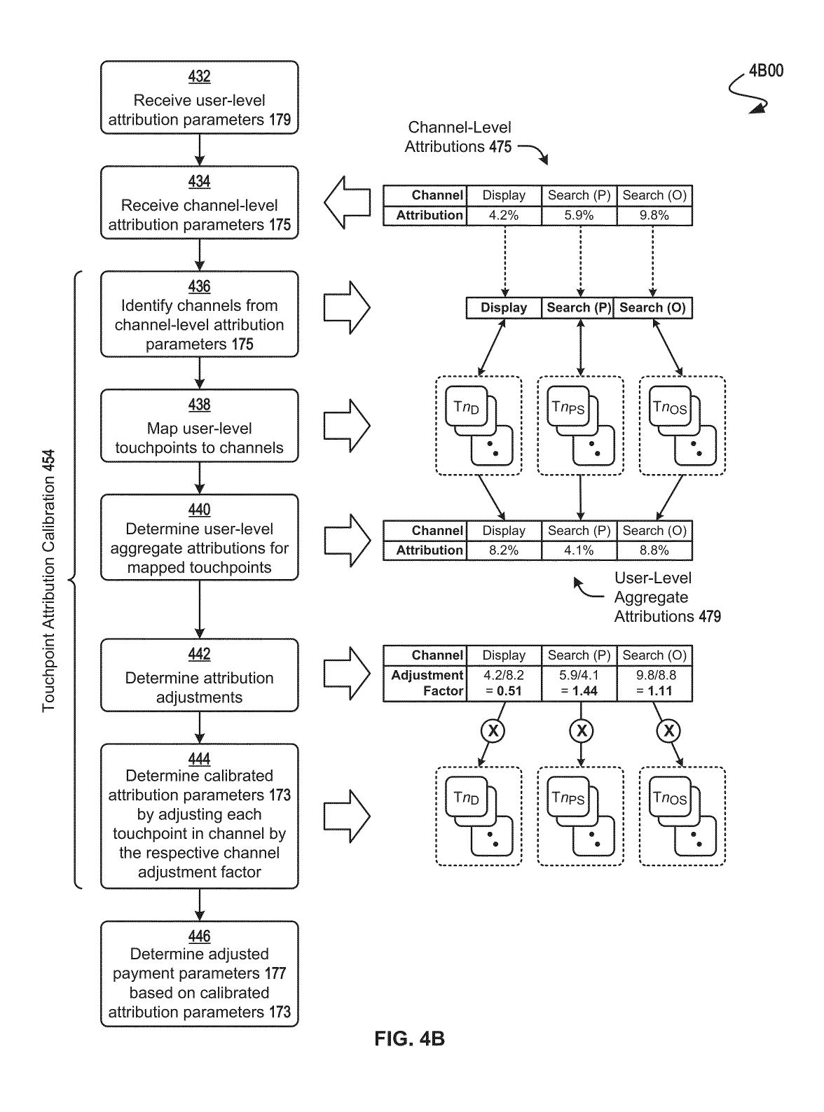

In some cases, a marketing manager might want to use such relative touchpoint contribution values provided by user-level or “bottom-up” attribution models (e.g., touchpoint response predictive model 168) to allocate spending in digital media channels at an intra-channel level (e.g., touchpoint level), yet take into account cross-channel factors (e.g., seasonality, etc.) provided by channel-level or “top-down” attribution models (e.g., channel response predictive model 162), Legacy approaches to applying top-down and bottom-up models to media spend allocation do not account for discrepancies that can exist among the models. The herein-disclosed techniques address such issues pertaining to reconciling channel-level attribution with user-level intra-channel attribution such that the marketing manager can account for seasonality and/or offline influences and/or other effects in the channel-level media spend allocations, yet also apply such effects to the digital intra-channel (e.g., touchpoint) media spend allocations. One embodiment of at least a portion of such techniques is discussed in FIG. 4A.

FIG. 4A depicts a response calibration technique 4A00 as implemented in systems for managing digital media spend allocation using calibrated user-level response data. As an option, one or more instances of response calibration technique 4A00 or any aspect thereof may be implemented in the context of the architecture and functionality of the embodiments described herein. Also, the response calibration technique 4A00 or any aspect thereof may be implemented in any desired environment.

FIG. 4A depicts process steps (e.g., response calibration technique 4A00) used in the calibration of touchpoint responses (see grouping 414) for use in the herein-disclosed techniques for managing digital media spend allocation using calibrated user-level response data. Other approaches and techniques for calibrating the user-level responses as implemented in the herein-disclosed techniques are possible. As shown, the channel spend allocation values (e.g., generated using the channel response predictive modeling technique 2A00) can be received by a computing device and/or system (e.g., measurement server 110) over a network (see step 402). For example, the digital channel spend allocation values 227 included in the channel spend allocation values 174 might indicate that aa % (e.g., of a certain budget) and/or $xxx US be allocated to the “Display” channel, and that bb % (e.g., of a certain budget) and/or $yyy US be allocated to the “Search” channel. In some cases, receiving the channel spend allocation values can be responsive to a detected change in at least one of the channel spend allocation values. As earlier mentioned, such allocations can be estimated by the channel response predictive model 162 and can take into account various cross-channel, seasonal, external, and/or other factors. Certain instances of the touchpoint attribute records 176 can further be received continually by a computing device and/or system (e.g., measurement server 110) over a network (see step 404). As shown, the touchpoint attribute records 176 can comprise various engagement stack progressions and an actual digital channel spend 427 representing the summary-level channel spend for the collected touchpoints. For example, the actual digital channel spend 427 might indicate that cc % (e.g., of a total spend) and/or $uuu US was spent in the “Display” channel, and that dd % (e.g., of a total spend) and/or $vvv US was spent in the “Search” channel. The engagement stack progressions and the actual digital channel spend 427 can be determined prior to development of a predictive model (e.g., prior to grouping 347 in FIG. 3A).

Given the information collected in step 402 and step 404, the response calibration portion (see grouping 414) can commence. In one or more embodiments, one objective of the response calibration is to modify the set of response data (e.g., touchpoint attribute records 176) to align to the channel-level attribution and/or allocation (e.g., digital channel spend allocation values 227) prior to being used to generate an intra-channel predictive model (e.g., touchpoint response predictive model 168). Specifically, as shown, the touchpoint attribute records 176 can be segmented by response channel (see step 406), such as “Display” and “Search”, for comparison to respective channels comprising the digital channel spend allocation values 227. The set of engagement stacks can then be analyzed to remove the touchpoints farthest from the conversion touchpoint in a given stack until the actual digital channel spend 427 is aligned or reconciled with the digital channel spend allocation values 227 (see step 408, decision 410, and path 412).

For example, touchpoint T6, touchpoint T4, and other touchpoints (e.g., not shown) might be removed until cc % approaches aa %, and dd % approaches bb %. In some cases, the difference between respective channels comprising the actual digital channel spend 427 and the digital channel spend allocation values 227 can be compared to a threshold value to determine when the touchpoint response calibration is complete (e.g., when decision 410 is affirmative). Upon completion of the touchpoint response calibration, the resulting set of calibrated touchpoint attribute records 178 can be used to generate the touchpoint response predictive model 168 (see step 420). In many cases, the resulting set of calibrated touchpoint attribute records has fewer records than the set of received touchpoint attribute records (e.g., due to removal of touchpoints farthest from the conversion touchpoint).

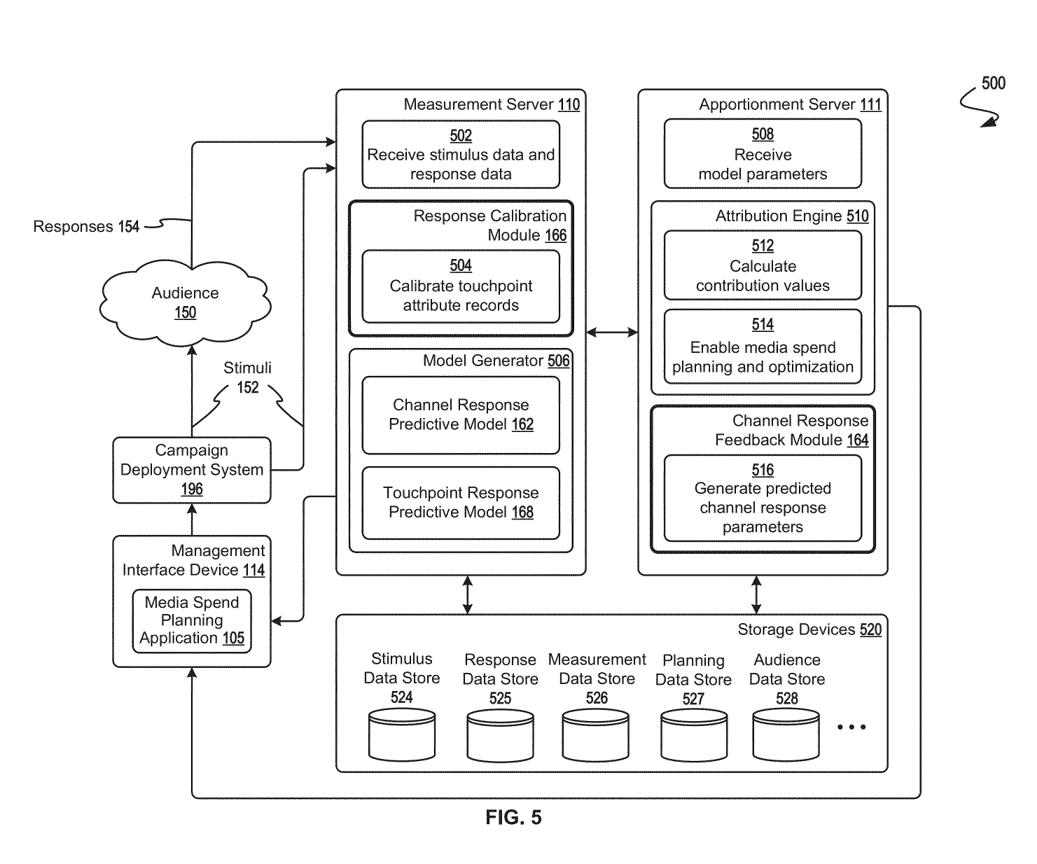

Using the touchpoint response predictive model 168 generated according to the response calibration technique 4A00 and other techniques disclosed herein, the media channel attribution (e.g., using the channel response predictive model 162) based on summary channel response data (e.g., channel response measurements 172), and the digital intra-channel media attribution (e.g., using the touchpoint response predictive model 168) based on user-level response data (e.g., touchpoint attribute records 176) can be reconciled, allowing the marketing manager to deploy the optimized non-digital channel media spend 192 and the optimized digital intra-channel media spend 194. One embodiment of a subsystem for implementing such techniques is discussed as pertains to FIG. 5.

In addition to the technique managing digital media spend allocation using calibrated user-level response data, some embodiments are configured so as to consider digital media spend allocation using calibrated attribution data.

FIG. 4B depicts an attribution calibration technique 4B00 as implemented in systems for managing digital media spend allocation using calibrated user-level attribution data. As an option, one or more instances of attribution calibration technique 4B00 or any aspect thereof may be implemented in the context of the architecture and functionality of the embodiments described herein. Also, the attribution technique 4B00 or any aspect thereof may be implemented in any desired environment.

FIG. 4B depicts process steps used in the calibration of touchpoint attribution (see grouping 454) for use in the herein-disclosed techniques. Other approaches and techniques for calibrating the user-level attribution as implemented in the herein-disclosed techniques are possible. As shown, a certain collection of the user-level attribution parameters 179 can be received (see step 432). In some cases, the user-level attribution parameters 179 can be received continually by a computing device and/or system over a network (e.g., the Internet). A certain set of the channel-level attribution parameters 175 can also be received (see step 434). For example, channel-level attribution parameters 175 might describe a set of channel-level attributions 475 for a “Display” channel, a paid search channel (e.g., “Search (P)”), and an organic search channel (e.g., “Search (O)”) for a certain time period. In some cases, the relative attributions (e.g., 4.2%, 5.9%, and 9.8%, respectively) might be different than the observed (e.g., measured) responses in the channels. For example, such differences might correspond to cross-channel effects, and/or other factors.

The operations comprising the touchpoint attribution calibration (see grouping 454) might commence with identifying the channels (e.g., “Display”, “Search (P)”, and “Search (O)”) associated with the received instances of the channel-level attribution parameters 175 (see step 436). The user-level touchpoints (e.g., from the received user-level attribution parameters) can be mapped to the earlier identified channels (see step 438). For example, a set of touchpoints (e.g., T1_{D}, T2_{D}, etc.) can be mapped to the “Display” channel. Also, a set of touchpoints (e.g., T1_{PS}, T2_{PS}, etc.) and a set of touchpoints (e.g., T1_{OS}, T2_{OS}, etc.) can be mapped to the “Search (P)” channel and the “Search (O)” channel, respectively. A set of user-level aggregate attributions 479 for each set of touchpoints mapped to the identified channels can be determined (see step 440). For example, a portion or all of the received instances of the user-level attribution parameters 179 can be used to determine the user-level aggregate attributions 479. One or more attribution adjustments can then be determined (see step 442). In the embodiment shown in FIG. 4B, the attribution adjustments can be derived from the channel-level attributions 475 and the user-level aggregate attributions 479. Specifically, an adjustment factor for each channel can be determined from the ratio of the respective channel-level attribution and the respective user-level aggregate attribution (e.g., “Display” adjustment factor=4.2/8.2=0.51). The attribution adjustments for each channel can then be applied to touchpoints mapped to each channel to determine a set of calibrated attribution parameters 173 (see step 444).

In some cases, a set of adjusted payment parameters 177 can be determined from the attribution adjustments and/or the calibrated attribution parameters 173. As an example, the adjusted payment parameters 177 can be used to reduce a payment to a demand fulfillment channel (e.g., delivering a certain impression touchpoint), since a demand stimulus channel (e.g., organic display channel) contributed to the actions culminating in demand fulfillment (see step 446). The payment difference (e.g., in dollars or another denomination) can be remitted to the authority for the subject demand stimulation channel. In some cases, the authority for the subject demand stimulation channel is the same as the authority for the demand fulfillment channel, so there is no net payment adjustment.

Using the attribution calibration technique 4B00 and other techniques disclosed herein, the media channel attribution (e.g., channel-level attributions 475) based on summary channel response data, and the digital intra-channel media attribution (e.g., user-level aggregate attributions 479) based on user-level response data can be reconciled (e.g., by user-level attributions described by the calibrated attribution parameters 173), allowing the marketing manager to deploy an optimized non-digital channel media spend and an optimized digital intra-channel media spend. One embodiment of a subsystem for implementing such techniques is discussed as pertains to FIG. 5.

FIG. 5 depicts a subsystem 500 for managing digital media spend allocation using calibrated user-level response data. As an option, one or more instances of subsystem 500 or any aspect thereof may be implemented in the context of the architecture and functionality of the embodiments described herein. Also, the subsystem 500 or any aspect thereof may be implemented in any desired environment.

As shown, subsystem 500 comprises certain components described in FIG. 1A. Specifically, the campaign deployment system 196 can present the stimuli 152 to the audience 150 to produce the responses 154. The measurement server 110 can receive electronic data records associated with the stimuli 152 and responses 154 (see operation 502). The stimulus data and response data can be stored in a storage area on one or more storage devices 520 (e.g., stimulus data store 524, response data store 525, audience data store 528, etc.). The measurement server 110 further comprises a model generator 506 that can use the stimulus data, response data, and/or other data such as calibrated touchpoint attribute records, to generate the channel response predictive model 162 and the touchpoint response predictive model 168. In some embodiments, the model parameters characterizing the channel response predictive model 162 and/or the touchpoint response predictive model 168 can be stored in the measurement data store 526. The response calibration module 166 operating on the measurement server 110 can calibrate the touchpoint attribute records (see operation 504) used by the model generator 506 to generate the touchpoint response predictive model 168. In some embodiments, the touchpoint attribute records comprise a certain portion of the response data received and stored by the measurement server 110.

As shown, the apportionment server 111 can receive the model parameters from the model generator 506 in the measurement server 110 (see operation 508) and enable an attribution engine 510 to calculate contribution values (see operation 512). For example, in some embodiments, the attribution engine 510 can use the channel response predictive model 162 to determine channel-level contribution values, and the touchpoint response predictive model 168 to determine intra-channel level contribution values. In some embodiments, such contribution values can be stored in a planning data store 527. The channel response feedback module 164 can also use the touchpoint response predictive model 168 to generate a set of predicted channel response parameters (see operation 516) for use by the model generator 506 to improve the accuracy of the channel response predictive model 162. The attribution engine 510 can further enable media spend planning and/or optimization (see operation 514) based in part on the data and/or operations availed by the subsystem 500. For example, the apportionment server 111 might provide access to instances of the channel response predictive model 162 and the touchpoint response predictive model 168 to enable a marketing manager to simulate various media spend scenarios using the media spend planning application 105 on the management interface device 114.

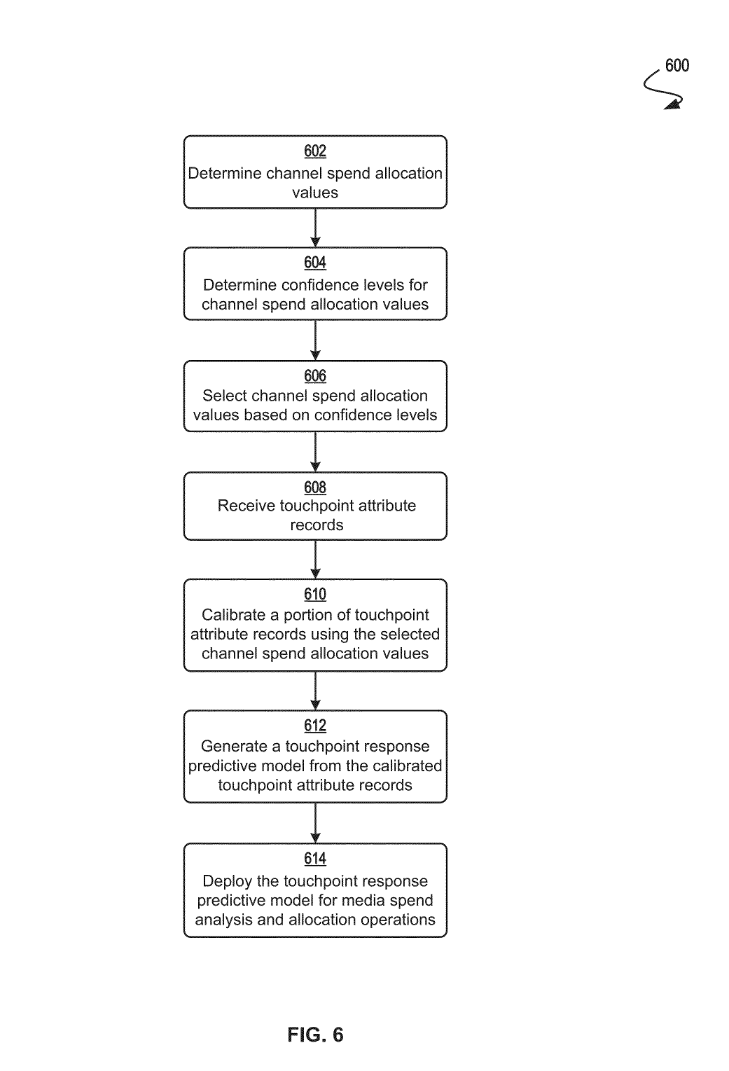

The subsystem 500 presents merely one partitioning. The specific example shown where the measurement server 110 comprises the response calibration module 166 and the model generator 506, and where the apportionment server 111 comprises the attribution engine 510 and the channel response feedback module 164 is purely exemplary, and other partitioning is reasonable, and the partitioning may be defined in part by the volume of empirical data. In some cases, a database engine can serve to perform calculations (e.g., within, or in conjunction with, a database engine query). A technique for managing digital media spend allocation using calibrated user-level response data implemented in such systems, subsystems, and some partitioning possibilities are shown in FIG. 6.

FIG. 6 depicts a flow 600 for managing digital media spend allocation using calibrated user-level response data. As an option, one or more instances of flow 600 or any aspect thereof may be implemented in the context of the architecture and functionality of the embodiments described herein. Also, the flow 600 or any aspect thereof may be implemented in any desired environment.

The flow 600 presents one embodiment of certain steps for managing digital media spend allocation using calibrated user-level response data. In one or more embodiments, the steps and underlying operations shown in the flow 600 can be executed by the measurement server 110 and apportionment server 111 disclosed herein. As shown, the flow 600 can commence with determining (e.g., using the channel response predictive modeling technique 2A00) channel spend allocation values (see step 602). A set of channel allocation confidence levels for the respective channel spend allocation values can also be determined (see step 604). For example, cross-channel contributions determined by a predictive model using statistical machine learning techniques, such as described herein, might have a channel allocation confidence level (e.g., a relative accuracy indicator) associated with a respective contribution value produced by the model. Such channel allocation confidence levels can be used to select a certain portion of the channel spend allocation values (see step 606). For example, the channel spend allocation values that have a respective channel allocation confidence level above a given threshold (e.g., 90%) can be selected for use in the technique depicted in flow 600. The flow 600 can continue to receive certain touchpoint attribute records (see step 608) and calibrate a portion of the touchpoint attribute records using the selected channel spend allocation values (see step 610). The calibrated touchpoint attribute records can then be used to generate (e.g., using the touchpoint response predictive modeling technique 3A00) a touchpoint response predictive model (see step 612) that can be deployed for various media spend analysis and allocation operations (see step 614).

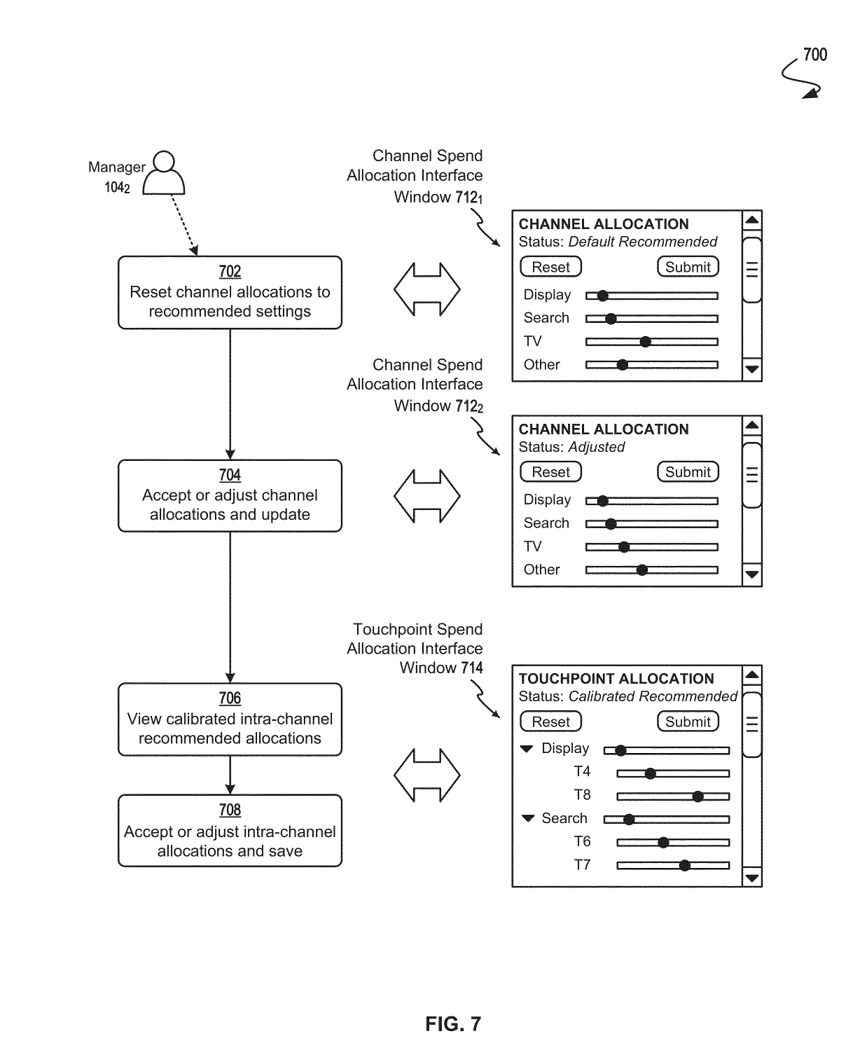

FIG. 7 is a chart 700 illustrating user interactions for selecting media spend allocations in systems for managing digital media spend allocation using calibrated user-level response data. As an option, one or more instances of chart 700 or any aspect thereof may be implemented in the context of the architecture and functionality of the embodiments described herein. Also, the chart 700 or any aspect thereof may be implemented in any desired environment.

FIG. 7 depicts certain actions a marketing manager (e.g., manager 104₂) might take in a use case for the herein disclosed techniques for managing digital media spend allocation using calibrated user-level response data. FIG. 7 further illustrates sample interface windows (e.g., channel spend allocation interface window 712₁, channel spend allocation interface window 712₂, and touchpoint spend allocation interface window 714) that the manager 104₂ might interact with in performing certain tasks. In some embodiments, the interface windows can be presented to the manager 104₂ by the media spend planning application 105 operating on the management interface device 114.

Specifically, the manager 104₂ might open the channel spend allocation interface window 712₁ in the app and reset the channel allocations to the recommended settings (see step 702). For example, the manager 104₂ can invoke the reset by clicking the “Reset” button in the channel spend allocation interface window 712₁ to present the “Default Recommended” settings graphically represented by the slider controls associated with each channel (e.g., “Display”, “Search”, “TV”, “Other”). In one or more embodiments, the default recommended settings can be derived from the channel contribution values (e.g., channel conversion contributions 224) estimated by the channel response predictive model 162. The manager 104₂ might then accept (e.g., by clicking “Submit” without changes) or adjust one or more channel allocations using the channel allocation slider controls (see step 704). For example, as shown in the channel spend allocation interface window 712₂, the manager 104₂ might adjust the allocations to the “TV” media channel and the “Other” media channel, yet allow the “Display” channel and “Search” channel to remain at the recommended settings. In one or more embodiments, the interface can provide a sum of the allocations (e.g., not shown) to inform the manager 104₂ of the compliance of any adjustments to a total percentage (e.g., 100%) and/or total spend budget.

When the channel spend allocations have been submitted, a most recent set of touchpoint attribute records can be calibrated to align with the channel-level allocations, such that the manager 104₂ can view, in real time, a set of calibrated intra-channel recommended spend allocations (see step 706). Specifically, the touchpoint spend allocation interface window 714 shows the recommended spends for touchpoint T4 and touchpoint T8 in the “Display” channel, and the recommended spends for touchpoint T6 and touchpoint T7 in the “Search” channel. As shown, the channel-level spend allocations submitted in the channel spend allocation interface window 712₂ can be applied to the aggregate channel spend for the respective channel in the touchpoint spend allocation interface window 714. The manager 104₂ can then accept or adjust the intra-channel allocations and click “Save” to deploy the allocations to the marketplace (see step 708), optimizing both the channel-level media spend, and the intra-channel media spend.

### Additional Practical Application Examples

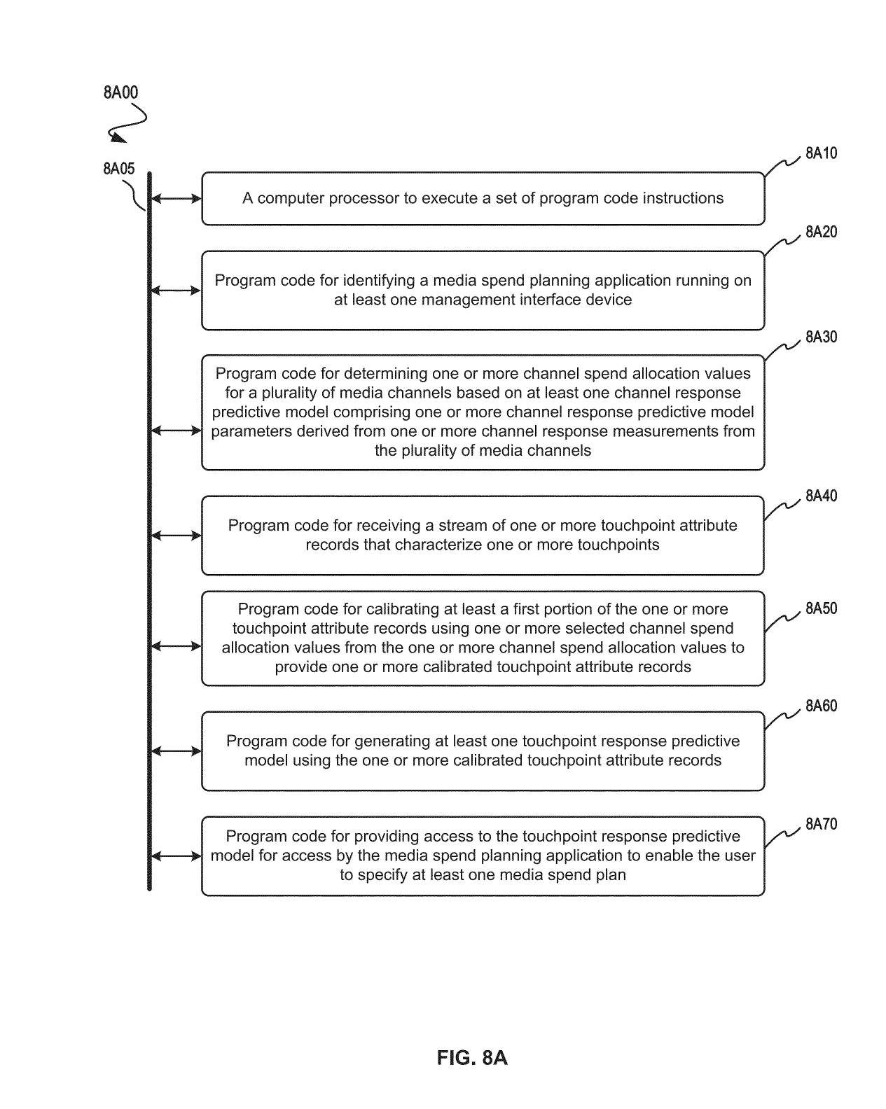

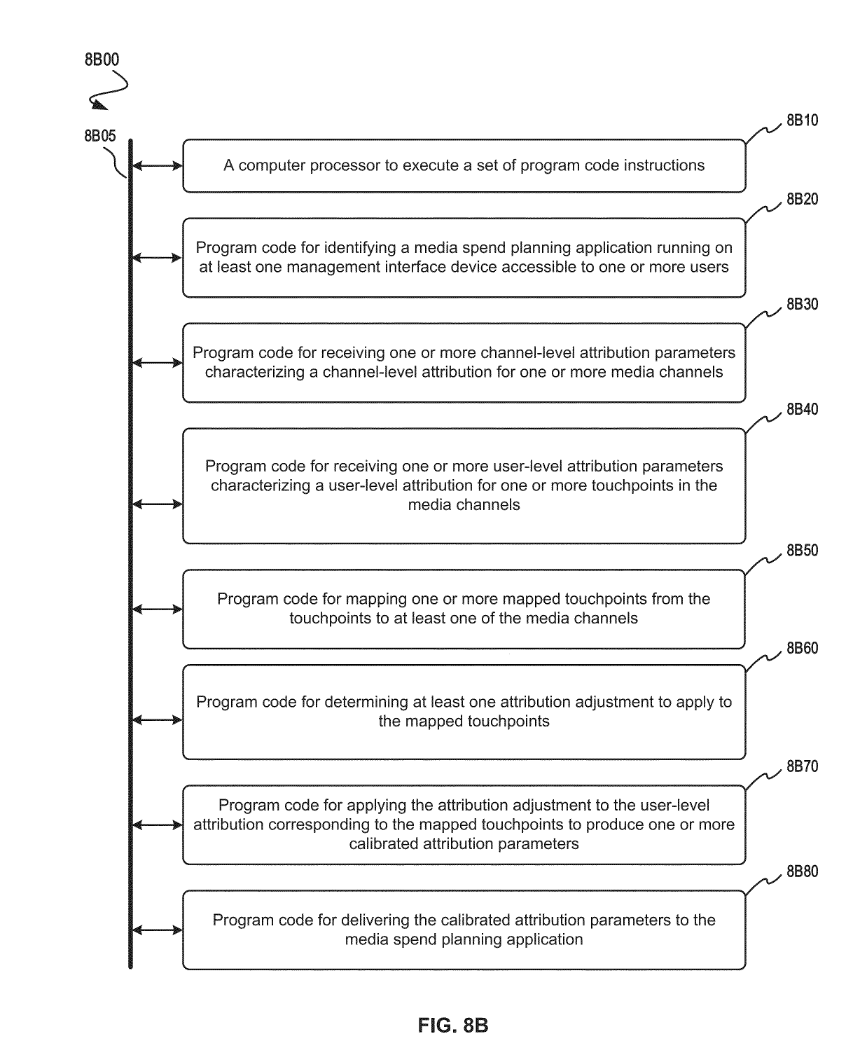

FIG. 8A is a block diagram of a system for managing digital media spend allocation using calibrated user-level response data, according to an embodiment. As an option, the present system 8A00 may be implemented in the context of the architecture and functionality of the embodiments described herein. Of course, however, the system 8A00 or any operation therein may be carried out in any desired environment. The system 8A00 comprises at least one processor and at least one memory, the memory serving to store program instructions corresponding to the operations of the system. As shown, an operation can be implemented in whole or in part using program instructions accessible by a module. The modules are connected to a communication path 8A05, and any operation can communicate with other operations over communication path 8A05. The modules of the system can, individually or in combination, perform method operations within system 8A00. Any operations performed within system 8A00 may be performed in any order unless as may be specified in the claims. The shown embodiment implements a portion of a computer system, presented as system 8A00, comprising a computer processor to execute a set of program code instructions (see module 8A10) and modules for accessing memory to hold program code instructions to perform: identifying a media spend planning application running on at least one management interface device (see module 8A20); determining one or more channel spend allocation values for a plurality of media channels based on at least one channel response predictive model comprising one or more channel response predictive model parameters derived from one or more channel response measurements from the plurality of media channels (see module 8A30); receiving a stream of one or more touchpoint attribute records that characterize one or more touchpoints (see module 8A40); calibrating at least a first portion of the one or more touchpoint attribute records using one or more selected channel spend allocation values from the one or more channel spend allocation values to provide one or more calibrated touchpoint attribute records (see module 8A50); generating at least one touchpoint response predictive model using the one or more calibrated touchpoint attribute records (see module 8A60); and providing access to the touchpoint response predictive model for access by the media spend planning application to enable the user to specify at least one media spend plan (see module 8A70).

FIG. 8B is a block diagram of a system for managing digital media spend allocation using calibrated user-level response data, according to an embodiment. As an option, the present system 8B00 may be implemented in the context of the architecture and functionality of the embodiments described herein. Of course, however, the system 8B00 or any operation therein may be carried out in any desired environment. The system 8B00 comprises at least one processor and at least one memory, the memory serving to store program instructions corresponding to the operations of the system. As shown, an operation can be implemented in whole or in part using program instructions accessible by a module. The modules are connected to a communication path 8B05, and any operation can communicate with other operations over communication path 8B05. The modules of the system can, individually or in combination, perform method operations within system 8B00. Any operations performed within system 8B00 may be performed in any order unless as may be specified in the claims. The shown embodiment implements a portion of a computer system, presented as system 8B00, comprising a computer processor to execute a set of program code instructions (see module 8B10) and modules for accessing memory to hold program code instructions to perform: identifying a media spend planning application running on at least one management interface device accessible to one or more users (see module 8B20); receiving one or more channel-level attribution parameters characterizing a channel-level attribution for one or more media channels (see module 8B30); receiving one or more user-level attribution parameters characterizing a user-level attribution for one or more touchpoints in the media channels (see module 8B40); mapping one or more mapped touchpoints from the touchpoints to at least one of the media channels (see module 8B50); determining at least one attribution adjustment to apply to the mapped touchpoints (see module 8B60); applying the attribution adjustment to the user-level attribution corresponding to the mapped touchpoints to produce one or more calibrated attribution parameters (see module 8B70); and delivering the calibrated attribution parameters to the media spend planning application (see module 8B80).

### Additional System Architecture Examples

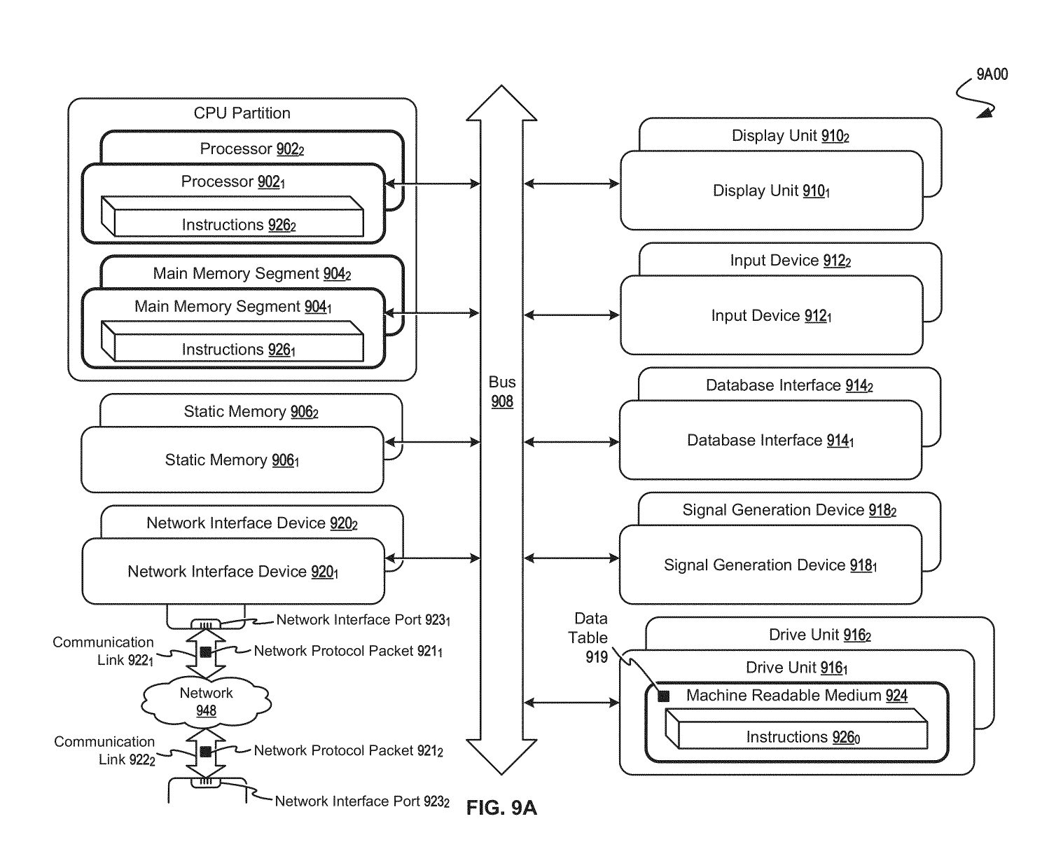

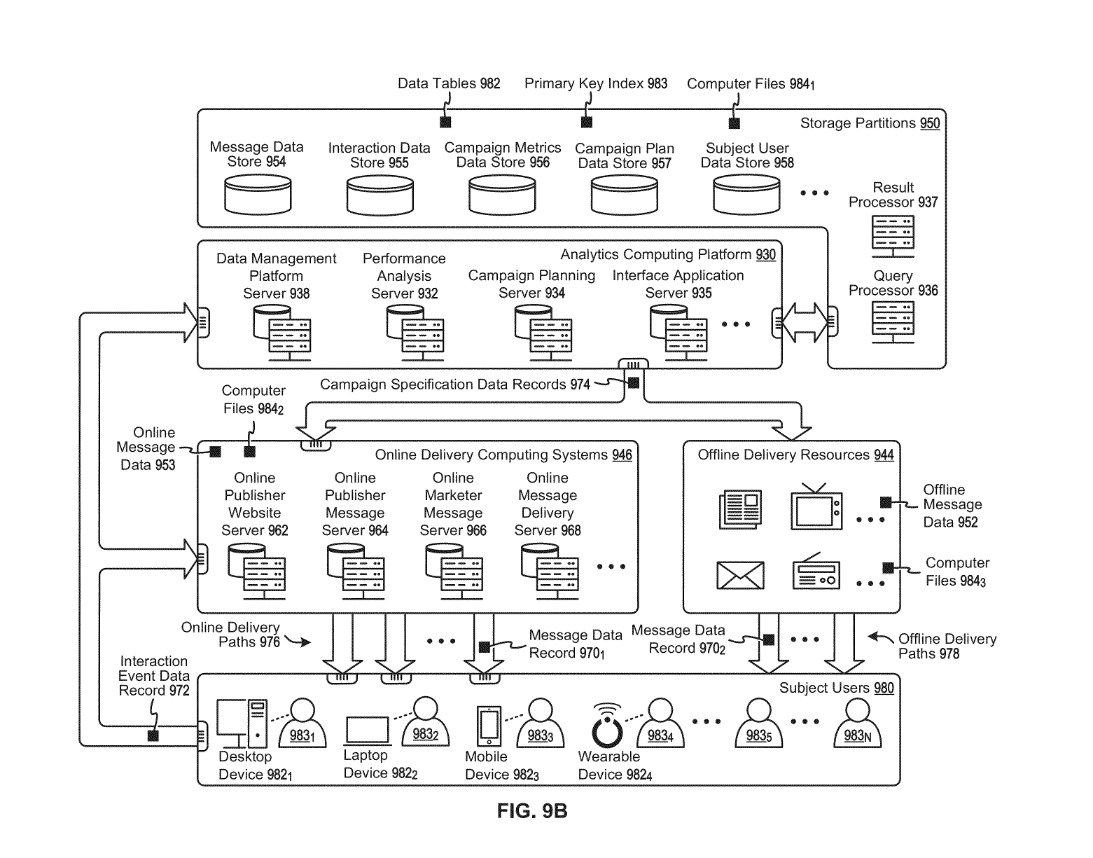

FIG. 9A depicts a diagrammatic representation of a machine in the exemplary form of a computer system 9A00 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 9A00 includes one or more processors (e.g., processor 902₁ processor 902₂, etc.), a main memory comprising one or more main memory segments (e.g., main memory segment 904₁, main memory segment 904₂, etc.), one or more static memories (e.g., static memory 906₁, static memory 906₂, etc.), which communicate with each other via a bus 908. The computer system 9A00 may further include one or more video display units (e.g., display unit 910₁, display unit 910₂, etc.), such as an LED display, or a liquid crystal display (LCD), or a cathode ray tube (CRT). The computer system 9A00 can also include one or more input devices (e.g., input device 912₁, input device 912₂, alphanumeric input device, keyboard, pointing device, mouse, etc.), one or more database interfaces (e.g., database interface 914₁, database interface 914₂, etc.), one or more disk drive units (e.g., drive unit 916₁, drive unit 916₂, etc.), one or more signal generation devices (e.g., signal generation device 918₁, signal generation device 918₂, etc.), and one or more network interface devices (e.g., network interface device 920₁, network interface device 920₂, etc.).

The disk drive units can include one or more instances of a machine-readable medium 924 on which is stored one or more instances of a data table 919 to store electronic information records. The machine-readable medium 924 can further store a set of instructions 926₀ (e.g., software) embodying any one, or all, of the methodologies described above. A set of instructions 926₁ can also be stored within the main memory (e.g., in main memory segment 904₁). Further, a set of instructions 926₂ can also be stored within the one or more processors (e.g., processor 902₁). Such instructions and/or electronic information may further be transmitted or received via the network interface devices at one or more network interface ports (e.g., network interface port 923₁, network interface port 923₂, etc.). Specifically, the network interface devices can communicate electronic information across a network using one or more optical links, Ethernet links, wireline links, wireless links, and/or other electronic communication links (e.g., communication link 922₁, communication link 922₂, etc.). One or more network protocol packets (e.g., network protocol packet 921₁, network protocol packet 921₂, etc.) can be used to hold the electronic information (e.g., electronic data records) for transmission across an electronic communications network (e.g., network 948). In some embodiments, the network 948 may include, without limitation, the web (i.e., the Internet), one or more local area networks (LANs), one or more wide area networks (WANs), one or more wireless networks, and/or one or more cellular networks.

The computer system 9A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media, optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 902₁, processor 902₂, etc.).

FIG. 9B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 948) using one or more electronic communication links (e.g., communication link 922₁, communication link 922₂, etc.). Such communication links may further use supporting hardware, such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals. In some embodiments, such signals are transmitted and received by the components at one or more network interface ports (e.g., network interface port 923₁, network interface port 923₂, etc.). In one or more embodiments, one or more network protocol packets (e.g., network protocol packet 921₁, network protocol packet 921₂, etc.) can be used to hold the electronic information comprising the signals.

As shown, the data processing system can be used by one or more advertisers to target a set of subject users 980 (e.g., user 983₁, user 983₂, user 983₃, user 983₄, user 983₅, to user 983_{N}) in various marketing campaigns. The data processing system can further be used to determine, by an analytics computing platform 930, various characteristics (e.g., performance metrics, etc.) of such marketing campaigns. Other operations, transactions, and/or activities associated with the data processing system are possible. Specifically, the subject users 980 can receive a plurality of online message data 953 transmitted through any of a plurality of online delivery paths 976 (e.g., online display, search, mobile ads, etc.) to various computing devices (e.g., desktop device 982₁, laptop device 982₂, mobile device 982₃, and wearable device 982₄). The subject users 980 can further receive a plurality of offline message data 952 presented through any of a plurality of offline delivery paths 978 (e.g., TV, radio, print, direct mail, etc.). The online message data 953 and/or the offline message data 952 can be selected for delivery to the subject users 980 based in part on certain instances of campaign specification data records 974 (e.g., established by the advertisers and/or the analytics computing platform 930). For example, the campaign specification data records 974 might comprise settings, rules, taxonomies, and other information transmitted electronically to one or more instances of online delivery computing systems 946 and/or one or more instances of offline delivery resources 944. The online delivery computing systems 946 and/or the offline delivery resources 944 can receive and store such electronic information in the form of instances of computer files 984₂ and computer files 984₃, respectively. In one or more embodiments, the online delivery computing systems 946 can comprise computing resources such as an online publisher website server 962, an online publisher message server 964, an online marketer message server 966, an online message delivery server 968, and other computing resources. For example, the message data record 970₁ presented to the subject users 980 through the online delivery paths 976 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 970₂ presented to the subject users 980 through the offline delivery paths 978 can be transmitted as sensory signals in various forms (e.g., printed pictures and text, video, audio, etc.).

The analytics computing platform 930 can receive instances of an interaction event data record 972 comprising certain characteristics and attributes of the response of the subject users 980 to the message data record 970₁, the message data record 970₂, and/or other received messages. For example, the interaction event data record 972 can describe certain online actions taken by the users on the computing devices, such as visiting a certain URL, clicking a certain link, loading a web page that fires a certain advertising tag, completing an online purchase, and other actions. The interaction event data record 972 may also include information pertaining to certain offline actions taken by the users, such as purchasing a product in a retail store, using a printed coupon, dialing a toll-free number, and other actions. The interaction event data record 972 can be transmitted to the analytics computing platform 930 across the communications links as instances of electronic data records using various protocols and structures. The interaction event data record 972 can further comprise data (e.g., user identifier, computing device identifiers, timestamps, IP addresses, etc.) related to the users and/or the users' actions.

The interaction event data record 972 and other data generated and used by the analytics computing platform 930 can be stored in one or more storage partitions 950 (e.g., message data store 954, interaction data store 955, campaign metrics data store 956, campaign plan data store 957, subject user data store 958, etc.). The storage partitions 950 can comprise one or more databases and/or other types of non-volatile storage facilities to store data in various formats and structures (e.g., data tables 982, computer files 984₁, etc.). The data stored in the storage partitions 950 can be made accessible to the analytics computing platform 930 by a query processor 936 and a result processor 937, which can use various means for accessing and presenting the data, such as a primary key index 983 and/or other means. In one or more embodiments, the analytics computing platform 930 can comprise a performance analysis server 932 and a campaign planning server 934. Operations performed by the performance analysis server 932 and the campaign planning server 934 can vary widely by embodiment. As an example, the performance analysis server 932 can be used to analyze the messages presented to the users (e.g., message data record 970₁ and message data record 970₂) and the associated instances of the interaction event data record 972 to determine various performance metrics associated with a marketing campaign, which metrics can be stored in the campaign metrics data store 956 and/or used to generate various instances of the campaign specification data records 974. Further, for example, the campaign planning server 934 can be used to generate marketing campaign plans and associated marketing spend apportionments, which information can be stored in the campaign plan data store 957 and/or used to generate various instances of the campaign specification data records 974. Certain portions of the interaction event data record 972 might further be used by a data management platform server 938 in the analytics computing platform 930 to determine various user attributes (e.g., behaviors, intent, demographics, device usage, etc.), which attributes can be stored in the subject user data store 958 and/or used to generate various instances of the campaign specification data records 974. One or more instances of an interface application server 935 can execute various software applications that can manage and/or interact with the operations, transactions, data, and/or activities associated with the analytics computing platform 930. For example, a marketing manager might interface with the interface application server 935 to view the performance of a marketing campaign and/or to allocate media spend for another marketing campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method comprising:
processing, in a computer, one or more channel response measurements, associated with a plurality of media channels and a marketing message, to determine a plurality of channel level attribution parameters for the media channels derived from at least one channel response predictive model, wherein the channel response predictive model accounts for one or more of cross-channel, seasonal, or external effects;
processing, in a computer, a plurality of touchpoint encounters, associated with the media channels and a plurality of users, to determine a plurality of user-level attribution parameters derived from at least one touchpoint response predictive model, wherein the user-level attribution parameters measure the effectiveness of the touchpoint encounters in eliciting a positive response from the users to the marketing message;
mapping the touchpoint encounters into respective media channels to generate mapped touchpoint encounters;
determining at least one attribution adjustment for each channel to apply to the mapped touchpoint encounters;
applying the attribution adjustment to the user-level attribution parameters corresponding to the mapped touchpoint encounters so as to produce one or more calibrated attribution parameters;
operating, on a computer, a media spend planning application accessible to one or more users, the media spend planning application receiving at least one budget for one or more media campaigns; and
processing the budget in the media spend planning application by using the calibrated attribution parameters to generate a spend allocation for the budget.

2. The computer implemented method of claim 1, further comprising generating one or more adjusted payment parameters based at least in part on at least one of, the attribution adjustment, or the calibrated attribution parameters.

3. The computer implemented method of claim 1, further comprising aggregating the user-level attribution parameters corresponding to the mapped touchpoints to form at least one user-level aggregate attribution.

4. The computer implemented method of claim 3, wherein determining the attribution adjustment is based at least in part on the user-level aggregate attribution.

5. The computer implemented method of claim 3, wherein the attribution adjustment is a ratio of the channel level attribution and the user-level aggregate attribution.

6. The computer implemented method of claim 1, wherein mapping the mapped touchpoints is based at least in part on a taxonomy.

7. The computer implemented method of claim 6, wherein the taxonomy comprises at least one attribute key and at least one attribute value.

8. The computer implemented method of claim 1, wherein determining the attribution adjustment is based at least in part on one of, the channel level attribution parameters, or the user-level attribution parameters.

9. The computer implemented method of claim 1, wherein the attribution adjustment is a ratio of at least one of the channel level attribution parameters and at least one of the user-level attribution parameters.

10. The computer implemented method of claim 1, wherein applying the attribution adjustment further comprises selecting a first portion of the touchpoints associated with the user-level attribution parameters.

11. A computer readable medium, embodied in a non-transitory computer readable medium, the non-transitory computer readable medium having stored thereon a sequence of instructions which, when stored in memory and executed by a processor causes the processor to perform a set of acts, the acts comprising:
processing, in a computer, one or more channel response measurements, associated with a plurality of media channels and a marketing message, to determine a plurality of channel level attribution parameters for the media channels derived from at least one channel response predictive model, wherein the channel response predictive model accounts for one or more of cross-channel, seasonal, or external effects,
processing, in a computer, a plurality of touchpoint encounters, associated with the media channels and a plurality of users, to determine a plurality of user-level attribution parameters derived from at least one touchpoint response predictive model, wherein the user-level attribution parameters measure the effectiveness of the touchpoint encounters in eliciting a positive response from the users to the marketing message;
mapping the touchpoint encounters into respective media channels to generate mapped touchpoint encounters;
determining at least one attribution adjustment for each channel to apply to the mapped touchpoint encounters,
applying the attribution adjustment to the user-level attribution parameters corresponding to the mapped touchpoint encounters so as to produce one or more calibrated attribution parameters;
operating, on a computer, a media spend planning application accessible to one or more users, the media spend planning application receiving at least one budget for one or more media campaigns; and
processing the budget in the media spend planning application by using the calibrated attribution parameters to generate a spend allocation for the budget.

12. The computer readable medium of claim 11, further comprising generating one or more adjusted payment parameters based at least in part on one of, the attribution adjustment, or the calibrated attribution parameters.

13. The computer readable medium of claim 11, further comprising aggregating the user-level attribution parameters corresponding to the mapped touchpoints to form at least one user-level aggregate attribution.

14. The computer readable medium of claim 13, wherein determining the attribution adjustment is based at least in part on the user-level aggregate attribution.

15. The computer readable medium of claim 13, wherein the attribution adjustment is a ratio of the channel level attribution and the user-level aggregate attribution.

16. The computer readable medium of claim 11, wherein mapping the mapped touchpoints is based at least in part on a taxonomy.

17. The computer readable medium of claim 16, wherein the taxonomy comprises at least one attribute key and at least one attribute value.

18. The computer readable medium of claim 11, wherein determining the attribution adjustment is based at least in part on one of, the channel level attribution parameters, or the user-level attribution parameters.

19. A system comprising:
a storage medium having stored thereon a sequence of instructions, and
a processor or processors that executed the instructions to causes the processor or processors to perform a set of acts, the acts comprising,
processing, in a computer, one or more channel response measurements, associated with a plurality of media channels and a marketing message, to determine a plurality of channel level attribution parameters for the media channels derived from at least one channel response predictive model, wherein the channel response predictive model accounts for one or more of cross-channel, seasonal, or external effects;
processing, in a computer, a plurality of touchpoint encounters, associated with the media channels and a plurality of users, to determine a plurality of user-level attribution parameters derived from at least one touchpoint response predictive model, wherein the user-level attribution parameters measure the effectiveness of the touchpoint encounters in eliciting a positive response from the users to the marketing message;
mapping the touchpoint encounters into respective media channels to generate mapped touchpoint encounters;
determining at least one attribution adjustment for each channel to apply to the mapped touchpoint encounters;
applying the attribution adjustment to the user-level attribution parameters corresponding to the mapped touchpoint encounters so as to produce one or more calibrated attribution parameters;
operating, on a computer, a media spend planning application accessible to one or more users, the media spend planning application receiving at least one budget for one or more media campaigns, and
processing the budget in the media spend planning application by using the calibrated attribution parameters to generate a spend allocation for the budget.

20. The system of claim 19, further comprising a storage device to store instructions for generating one or more adjusted payment parameters based at least in part on one of, the attribution adjustment, or the calibrated attribution parameters.
